(19) United States
(12) Patent Application Publication
(10) Pub. No.: US 2024/0041023 A1
(43) Pub. Date: Feb. 8, 2024

(54) COMPOSITION AND METHOD OF PRESERVING VIABILITY OF CELL IN A LOW TEMPERATURE

(71) Applicants: THE UNITED STATES OF AMERICA, AS REPRESENTED BY THE SECRETARY, DEPARTMENT OF HEALTH & HUMAN SERVICES, Bethesda, MD (US); Third Affiliated Hospital of Sun Yat-Sen University, Guangzhou (CN)

(72) Inventors: Jingxing OU, Bethesda, MD (US); Guanghui JIN, Guangzhou City (CN); Yang YANG, Guangzhou (CN); Wei LIU, Guangzhou (CN); Lihao GE, Rockville, MD (US); Kiyoharu Joshua MIYAGISHIMA, Laurel, MD (US); Wei LI, Potomac, MD (US)

(21) Appl. No.: 18/258,125

(22) PCT Filed: Dec. 17, 2021
(86) PCT No.: PCT/US2021/064086

§ 371 Date: Jun. 16, 2023

(30) Foreign Application Priority Data
Dec. 17, 2020 (CN) 202011500962.5

(51) Int. Cl. A01N 1/02

(52) U.S. Cl. CPC A01N 1/0284; A01N 1/0221; A01N 1/0226

(57) ABSTRACT

Composition for treating a cell, tissue or organ to withstand exposure and/or preserve viability when exposed to a low temperature environment, and methods for using such compositions. The cell, tissue, or organ is preferably a cornea or corneal cell.

### STATEMENT OF GOVERNMENT SUPPORT

This invention was made with government support under 1ZIAEY000488 awarded by National Eye Institute (NEI). The government has certain rights in the invention.

### CROSS-REFERENCE TO RELATED APPLICATIONS

This application claims the benefit of Chinese Application No. 202011500962.5, filed Dec. 17, 2020, the contents of which are herein incorporated by reference in their entirety.

### BACKGROUND

Corneal transplantation is used to replace a damaged or diseased cornea in a recipient individual with a donated cornea. Once removed from the donor, the corneal tissue is maintained under conditions designed to maximize cellular survival prior to grafting of the tissue in the recipient. A successful outcome in a corneal transplantation is dependent upon the presence of a viable corneal endothelium. The corneal endothelium is a monolayer of cells lining the inner surface of the cornea, at the boundary between the aqueous humor-filled anterior chamber and the clear stroma at the posterior surface. The corneal endothelium acts as a barrier to fluid movement into the cornea and functions to maintain corneal transparency through the regulation of stromal hydration. These cells are extremely fragile and do not divide under normal circumstances, and thus function of the corneal endothelium depends on maintaining a high cell population for proper repair mechanisms.

The preservation and storage of a cornea containing living cells can be accomplished through cold temperature storage (e.g., 2-8° C.), cryopreservation, and organ culture. Cold storage at temperatures of 2-8° C. reduces the need for metabolic energy within the cells, and can generally be used to store corneas for 1 to two weeks (7-14 days).

Storage media or corneal preservation solutions have been developed for effective preservation of the cornea. In 1947, McCarey found that the cornea was intact as a fresh cornea when stored in M-K solution for 4 days at 4° C. Then, chondroitin sulfate and other chemical substances were added into the M-K solution to develop further preservation solutions such as K-Solution, CSM. Dexsol. In 1990, Optisol-GS™, the corneal preservation solution that is now most widely used, was formed by combining K-solution with Dexsol and adding streptomycin. The experimental data show that the cornea activity can be explained for 7-10 days (according to NEI guideline for functional preservation of the cornea). Other improved preservation solutions such as Chen's preservation solution were also followed, but none of the preservation effects could be compared to Optisol-GS™.

However, the conventional organ preservation solution represented by Optisol-GS™ only has the effect of preserving the cornea for a short amount of time, and after 12 days, the cornea is generally edematous and blurred, and endothelial cells are killed and shed in a large area. Such cold preserved corneas often result in failure of corneal transplant surgery. The 12-day shelf life cannot meet the requirement of larger eye bank preservation, and a better corneal preservation strategy is urgently needed to meet the requirement.

Cryopreservation is a process where biological samples such as cells or whole tissues are preserved by cooling to low sub-zero temperatures. At such low temperatures, any biological activity, including the biochemical reactions that would normally lead to cell death, is effectively stopped. Cryopreservation allows for the preservation and storage of cells or tissues while preserving their potential biological activity. Organ culture includes storage of the cornea in a medium such as Eagle's minimum essential medium (MEM) with 2% fetal bovine serum (FBS), at a temperature of 28-37° C. Organ culture allows for storage up to 4-7 weeks.

Cold storage at temperatures of 2-8° C. is the most common method of cornea storage prior to transplantation. However, the corneal endothelium is susceptible to damage during cold storage of the cornea prior to transplant. If the number of cornea endothelial cells is too low, the repair mechanisms may be insufficient to restore the endothelium and maintain the cornea in proper functioning state, i.e., capable of acting as a proper permeability barrier and maintaining the cornea in its clear, non-swollen state. In addition, corneal endothelial cells have a very limited capacity for proliferation in the human body. Improper functioning of the corneal endothelium is a root cause of the failure of a majority of corneal transplants. As a result, there is often a need to discard a cornea due to the loss of endothelial cells, as evidenced when the cornea becomes swollen or loses clarity. Preservation of the corneal endothelium during storage prior to transplantation is thus a key concern in ensuring a successful corneal transplant.

There remains a need for an improved composition and method for preserving the viability of cells, tissues, and organs during storage at temperatures of 2-8° C., over a prolonged period of time.

### BRIEF DESCRIPTION

Disclosed herein is a method of treating a cell, tissue, or organ to withstand exposure to a low temperature environment, the method comprising:
providing the cell, tissue, or organ to be exposed to the low temperature environment; and contacting the cell, tissue, or organ with a composition comprising a compound which activates FOX01 protein in the cell, tissue, or organ, to enable the cell, tissue, or organ to withstand exposure to the low temperature.

Also disclosed herein is a method of preserving viability of a cell, tissue, or organ during exposure to a low temperature environment, the method comprising:
contacting the cell, tissue, or organ with a composition comprising a compound which activates FOX01 protein in the cell, tissue, or organ, effective to preserve the viability of the cell, tissue, or organ; and
exposing the contacted cell, tissue, or organ to the low temperature environment.

In an embodiment, the cell, tissue, or organ is a cornea or a corneal cell.

In an embodiment, the compound which activates FOXO1 protein is a cell permeable ceramide analog or Apigenin.

Also disclosed herein is use of a composition comprising a compound which activates FOXO1 protein in the cell, tissue, or organ to treat or preserve viability of a cell, tissue, or organ to withstand exposure to a low temperature environment.

Also disclosed herein is use of a composition comprising a compound which activates FOXO1 protein for the manufacture of a medicament to treat or preserve viability of a cell, tissue, or organ to withstand exposure to a low temperature environment.

Also disclosed herein is a preservation solution comprising the following components, in 1 L calculation:

### Amino Acid:

Alanine 1.5-2.2 mg
Arginine 75-93 mg
Asparagine 14-17 mg
Cysteine 0.9-1.1 mg
Glycine 27-33 mg
Glutamine 180-220 mg
Histadine 28-34 mg
Isoleucine 94-120 mg
Leucine 94-120 mg
Lysine 100-130 mg
Methionine 27-33 mg
Phenylalanine 59-73 mg
Proline 7-8.5 mg
Serine 36-46 mg
Threonine 85-105 mg
Tryptophan 14-18 mg
Tyrosine 60-80 mg
Valine 84-105 mg

### Vitamins:

Choline 4-5.2 mg
D-Calcium pantothenate 3-4.5 mg
Pantothenic acid (Vitamin B5) 0.9-1.1 mg
Folic acid 4-5 mg
Niacinamide 4-5 mg
Pyridoxal (Vitamin B6) 4-5 mg
Riboflavin (vitamin B2) 0.09-0.11 mg
Thiamine (Vitamin B1) 5-6.5 mg
Vitamin B12 1-1.5 mg

### Inorganic Salt:

CaCl₂) 170-220 mg
Fe(NO₃)₃ 50-70 mg
KCl 360-440 mg
NaHCO₃66-85 mg
NaCl 4300-5300 mg
NaH₂PO₄ 120-160 mg
MgCl₂ 69-85 mg
ZnSO₄ 97-120 mg

### Other Components:

Adenosine 1.3-1.7 mg
Chondroitin sulfate 22000-28000 mg
Glucose 4000-5000 mg
Dextran 9000-11000 mg
Gentamicin 90-110 mg
Inosine 9-12 mg
Inositol 10-14 mg
Phenol red 330-420 mg
Pyridoxal Hydrochloride 0.9-1.1 mg
MES monohydrate 220-280 mg
MOPS buffer 9000-11000 μm
HEPES buffer 1800-2200 μm
Sodium pyruvate 0.9-1.2 mg
2-mercaptoethanol 3.4-4.3 mg,
wherein the preservation solution has a pH of 7.3±2, and an osmotic pressure of 300±50 mOsm.

In an embodiment, the preservation solution is a corneal preservation solution.

In an embodiment, the preservation solution further comprising at least one selected from the group consisting of a compound which activates FOXO1 protein in the cell, tissue, or organ and a protease inhibitor mixture (Pi).

In an embodiment, the compound which activates FOXO1 protein is a cell permeable ceramide analog or Apigenin.

Also disclosed herein is a method of treating a cell, tissue, or organ to withstand exposure to a low temperature environment, the method comprising:
providing the cell, tissue, or organ to be exposed to the low temperature environment; and contacting the cell, tissue, or organ with the preservation solution discussed herein to enable the cell, tissue, or organ to withstand exposure to the low temperature.

Also disclosed herein is a method of preserving viability of a cell, tissue, or organ during exposure to a low temperature environment, the method comprising:
contacting the cell, tissue, or organ with the preservation solution as discussed herein to preserve the viability of the cell, tissue, or organ; and
exposing the contacted cell, tissue, or organ to the low temperature environment.

Also disclosed herein is use of the preservation solution as discussed herein in the cell, tissue, or organ to treat or preserve viability of a cell, tissue, or organ to withstand exposure to a low temperature environment.

Also discussed herein is use of the preservation solution of any one of claims 40-54 for the manufacture of a medicament to treat or preserve viability of a cell, tissue, or organ to withstand exposure to a low temperature environment.

The above described and other features are exemplified by the following figures and detailed description.

### BRIEF DESCRIPTION OF THE DRAWINGS

The following figures are exemplary embodiments wherein the like elements are numbered alike.

FIG. 1 shows the staining results of the cornea of 4 weeks old rat cornea and 6 months old rat cornea. DAPI stains cell nucleus (blue), PI stains dead cells (red).

FIG. 2 shows FOXO1 staining results of 4 weeks old rat cornea and 6 month old rat cornea. DAPI stains cell nucleus (blue), Phalloidin stains endothelial cell membrane/F-actin (pink), and FOXO1 protein (green).

FIG. 3 shows FOXO1 staining results before and after injection of C6 into the corneal anterior chamber of a 6-month-old rat and shows the effects of C6 on FOXO1 nuclear entry in rat corneal endothelial cells. DAPI: nucleus (blue), Phalloidin: F-actin (pink), and FOXO1 protein (green).

FIG. 4 shows FOXO1 staining results before and after Apigenin injection into the corneal anterior chamber of a 6-month old rat and after rewarming, and shows the effects of Apigenin on FOXO1 nuclear entry in rat corneal endothelial cells; DAPI: nucleus (blue), Phalloidin: F-actin (pink), FOXO1 protein (green).

FIGS. 5A and 5B show FOXO1 staining results after injection of C6 and goat serum into the corneal anterior chamber of 6-month-old rats, removal, and then cold preserving the cornea for 3 weeks in different corneal preservation solutions. The data suggests that C6 and Pi can be added to Optisol-GS™ and/or the novel corneal preservation solution (MCM) and enhance rat corneal endothelial cell survival. DAPI: nucleus (blue), PI: dead cells (red), Phalloidin: F-actin (pink), FOXO1 protein (green).

FIG. 6 shows a graph of corneal endothelial cell mortality after cornea of 6-month old rat was subjected to anterior chamber injection with C6 and goat serum and then subjected to cold preservation for 3 weeks in different corneal preservation solutions.

FIG. 7 shows cornea permeability results of 6-month old rats after anterior chamber injection of C6 and goat serum, removal, and then cold storage for 3 weeks in different corneal preservation solutions.

FIGS. 8A and 8B show FOXO1 staining results after injecting C6 and goat serum into the corneal anterior chamber of a 6-month-old rat and then cold storing the cornea for 4 weeks in different corneal preservation solutions. The staining result image shows DAPI: nucleus (blue), PI: dead cells (red), Phalloidin: F-actin (pink), FOXO1 protein (green).

FIG. 9 shows cornea permeability results of 6 month old rats after anterior chamber injection of C6 and goat result, and then cold stored for 4 weeks in different corneal preservation solutions.

FIG. 10 shows corneal endothelial cell death rate after injection of C6 and goat serum into the corneal anterior chamber of a 6-month-old rat, and then cold preserved for 4 weeks in different corneal preservation solutions.

FIG. 11 shows FOXO1 staining results after injection of Apigenin and goat serum into the corneal anterior chamber of a 6-month-old rat, and then cold storing for 3 weeks in different corneal preservation solutions. DAPI: cell nucleus (Blue), PI: dead cells (red), Phalloidin: F-actin (pink), FOXO1 protein (green).

FIG. 12 shows FOXO1 staining results after injection of apigenin and goat serum into the corneal anterior chamber of a 6-month-old rat, and then cold storing for 4 weeks in different corneal preservation solutions. The data shows that rat corneas can be stored with Apigenin at 4° C. for 28 days with a largely intact endothelium. DAPI: cell nucleus (Blue), PI: dead cells (red), Phalloidin: F-actin (pink), FOXO1 protein (green).

FIG. 13 shows corneal endothelium death rate after injection of C6 and goat serum into the corneal anterior chamber of a 6-month-old rat, and then cold preserving for 3 and 4 weeks in various different corneal preservation solutions.

FIG. 14 shows images of rat eyes 3 weeks after corneal transplantation. C6 and goat serum were injected into fresh cornea and corneal anterior chamber of 6-month-old rats, and the cornea was then cold preserved in various corneal preservation solutions for 4 weeks.

FIG. 15 shows transmission electron microscopy micrographs corneal endothelial subcellular structures 6 months after corneal transplantation. Except for the ‘fresh’ cornea control, the other 3 groups were from cold-stored corneas 6 months after the transplantation surgery.

FIG. 16A shows FOXO1 nuclear accumulation in the retinas of torpid ground squirrels (TLGS) and active TLGS following cold storage. FIG. 16B shows FOXO1 nuclear accumulation in cultured TLGS iPSC neurons at indicated conditions.

FIG. 17 shows, in panels A-D, FOXO1 nuclear accumulation in cultured young human iPSC neurons and adult human iPSC neurons at indicated conditions.

FIG. 18 shows cold survival in human H1 embryonic stem cells is dependent on FOXO1 nuclear entry and deteriorated by ‘aging’ factors.

FIGS. 19A and 19B shows FOXO1 in mouse heart sections from indicated conditions.

FIGS. 20A and 20B shows FOXO1 in zebrafish larvae from indicated conditions.

FIG. 21 shows, in panels A-C, cold-induced FOXO1 nuclear entry is enabled by SUMO E3 ligase RANBP2 and transporter protein Importin-7, and inhibited by transporter protein Exportin-1. Deteriorated functions of RANBP2 and Importin-7 may be the reason of the repression of FOXO1 nuclear entry following cold stress in older H1 cells.

FIG. 22 shows, in panels A-B, cold-induced FOXO1 nuclear entry is also determined by a key SUMO-interacting motif (SIM) on the N-terminal of the FOXO1 protein; if the SIM motif is mutated, FOXO1 proteins will accumulate in cell nucleus at normal condition.

FIG. 23 shows, in panels A-E, various images using mouse pancreatic islets as a model. The key components in the FOXO1-dependent survival pathway are NOT well maintained in the current gold standard organ preservation solution (UW, University of Wisconsin solution). If the deSUMOylation inhibitor N-Ethylmaleimide (N-EM; see FIG. 24C) was added into the UW solution, islet cold survival is improved; if a basal preservation solution (HS) was used, islet cold survival is even better; 3) Even in the HS solution, if SUMOylation inhibitor 2-D08 or ginkgolic acid was added (GA, FIGS. 24B and 24D), cold-induced FOXO1 nuclear entry was repressed, and islet cell death became severe.

FIG. 24 shows, in panels A-C, show images of mouse pancreatic islets and sections of mouse kidneys with translated islets. N-EM and protease inhibitors were added into HS to make HS+. Mouse islets can be stored in HS+ for up to 14 days at 4° C., transplanted into streptozotocin (STZ)-induced type I diabetic mice and successfully reduce the blood glucose levels of the recipient mice.

FIG. 25 shows, in panels A-C, graphs of insulin production/secrection due to being preserved in either UW or HS+ preservation solutions. It can be seen that HS+ preservation solution can significantly improve the quality of human islets after prolonged cold storage.

### DETAILED DESCRIPTION

Disclosed herein is composition and method of using the composition to treat a cell, tissue or organ to withstand exposure, preserve viability, and/or reduce damage when exposed to a low temperature environment. In an embodiment, the cell, tissue, or organ can be a cornea or corneal cell or a pancreatic islet or cell, preferably a cornea or corneal cell.

The Forkhead box 01 (FOXO1) protein is a transcription factor belonging to the family of transcription factors having a forkhead box or motif, and which is a DNA-binding domain having about 80 to 100 amino acids and made up of three helices and two characteristic large loops. The FOXO1 protein is involved in the regulation of metabolic homeostasis in response to oxidative stress, and is shuttled between the nucleus and the cytoplasm of a cell. Phosphorylation of FOXO1 results in inactivation of the protein and its exclusion from the nucleus where it is subject to ubiquitination and degradation. In contrast, non-phosphorylated and activated FOXO1 is localized in the nucleus where it induces the expression of various genes involved in apoptosis, glucose metabolism, cell cycle progression, and differentiation.

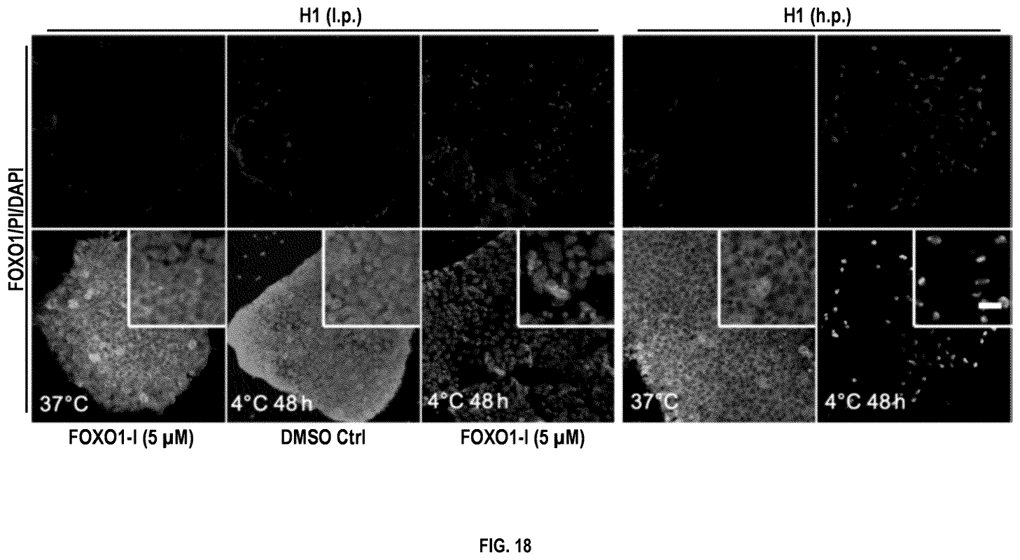

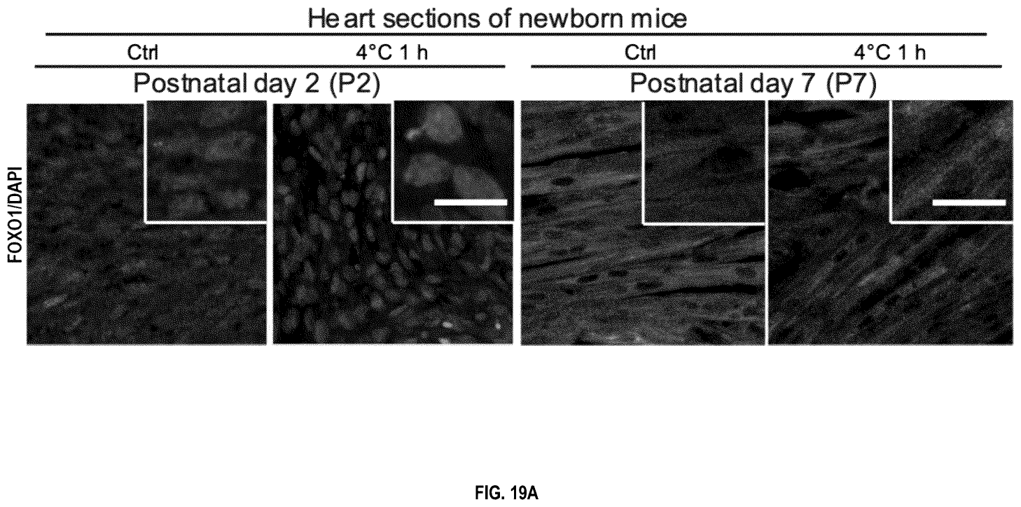

It has been unexpectedly discovered that exposure to low temperatures induces nuclear accumulation and activation of FOXO1 in human corneal cells derived from young donors, and that FOXO1 expression is related to the long-term survival of the human corneal cells in vitro. See FIGS. 18A-B, 19A-D, 20, 21A-B, and 22A-B. It has also been unexpectedly discovered that treating the cornea with a composition comprising a compound which results in activation of FOXO1 in corneal endothelial cells results in increased viability of the corneal endothelial cells during long term storage of the cornea in low temperature conditions. In an embodiment, corneas treated with a composition comprising the compound which results in activation of FOXO1 can be cold stored for at least 4 or 5 weeks with greater than 95% endothelial cell survival. The compound which results in activation of FOXO1 can be either a cell permeable ceramide analog or Apigenin. In contrast, corneas cold stored only in standard corneal storage medium resulted in rates of endothelial cell deaths of up to 90-100% (0-10% viability) within a similar period of time.

“Treatment” or “treating” as used herein includes providing the compounds disclosed herein as the active agent in an amount effective to measurably obtain the desired effect, e.g., maintain viability and/or reduce damage.

An “effective amount” of an active ingredient, or a composition including the active ingredient, is an amount effective, when administered, to provide a therapeutic benefit.

A significant change is any detectable change that is statistically significant in a standard parametric test of statistical significance such as Student's T-test, where p<0.05.

As used herein, “low temperature storage” or “cold storage” are used interchangeably and refer to a temperature of 2-8° C. unless otherwise indicated.

A “viable” cell or the “viability” of a cell refer to the capacity of a cell to perform certain natural functions such as metabolism, growth, movement, reproduction, some form of responsiveness, and adaptability. “Cell survival” is also similarly intended.

As used herein “preserve viability” or “preserving viability” means that the number of viable cells present in a cell population, or a tissue comprising the cell population, is substantially the same following cold storage as the number of viable cells present prior to the cold storage. For example, preserving the viability of a cell population, or a tissue comprising the cell population, means that at least 80%, at least 85%, at least 90%, at least 95%, at least 97%, at least 99%, or 100% of the cells are viable after a defined period of cold storage. Preserving viability also means that 20% or less, 10% or less, 8% or less, 5% or less, 3% or less, or 1% or less of the cells are not viable (did not survive) when comparing the number of viable cells present after cold storage to the number of viable cells present prior to the start of cold storage.

“Alkyl” means a straight or branched chain, saturated, monovalent hydrocarbon group (e.g., methyl or hexyl).

As used herein a “corneal cell” is a cell contained within an intact cornea, and is not intended to refer to cells which have been isolated from a cornea and cultured independently.

Disclosed herein is a composition for preserving the viability and reducing damage of cells, tissues, or organs during exposure to a low temperature environment. In an embodiment, the composition comprises a compound which results in activation of FOXO1 in the cell, tissue, or organ.

In an embodiment, cell, tissue, or organ is a mammalian cell, tissue, or organ, which include neuronal cells, retinal cells, cornea, retina, skin, heart, lung, pancreas, kidney, liver, intestine, stem cells, blood, or any other cell, tissue, or organ that is suitable for transplantation. In an embodiment, the cell, tissue, or organ can be a cornea or corneal cell or a pancreatic islet or cell, preferably a cornea or corneal cell, even more preferably a corneal endothelial cell.

In an embodiment, the compound can be any compound that drives FOXO1 translocation to the nucleus or prevent its expulsion from the nucleus. In an embodiment, the compound can be a cell permeable ceramide analog, Apigenin, N-EM (deSumoylation inhibitor), resveratrol, or Leptomycin B (LMB). N-EM (deSumoylation inhibitor) and resveratrol induce FOXO1 translocation to the nucleus. Leptomycin B (LMB) is a nuclear export inhibitor of exportin-1/CRM1 which causes FOXO1 to accumulate in the nucleus. In an embodiment, the compound is a cell permeable ceramide analog or Apigenin.

In an embodiment, the compound which results in activation of FOXO1 is a cell permeable ceramide analog, wherein the cell permeable ceramide analog comprises a compound represented by Formula 1,

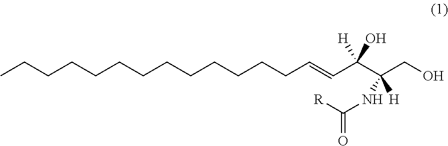

wherein R is a C1 to C10 alkyl group.

In an embodiment, the cell permeable analog comprises a compound represented by Formula 2, also known as C6 ceramide.

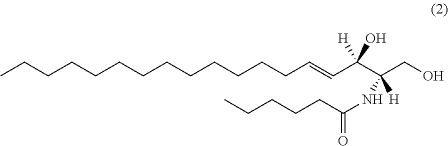 [SMILES: CCCCCCCCCCCCC/C=C/[C@@H](O)[C@H](CO)NC(=O)CCCCC]

In an embodiment, the compound which results in activation of FOXO1 is Apigenin.

In an embodiment, the compound which results in activation of FOXO1 can be dissolved in any physiological solution deemed suitable for the cell, tissue, or organ prior to contacting the cell, tissue, or organ. The compound can also be combined with a commercially available or novel medium as discussed herein designed for low temperature cell, tissue, or organ storage (preservation solution). In an embodiment, the composition comprises the compound which results in activation of FOXO1 and a preservation solution. Any suitable physiological solution or preservation solution that does not interfere with the function of the compound which results in activation of FOXO1, whether commercially available or novel as discussed herein can be used. In an embodiment, the cell, tissue, or organ can be a cornea or corneal cell or a pancreatic islet or cell, preferably a cornea or corneal cell, even more preferably a corneal endothelial cell.

In an embodiment, the preservation solution is a corneal preservation solution. In an embodiment, the preservation solution is known. In an embodiment, the preservation solution is the novel preservation solution discussed herein.

Examples of known corneal preservation solution developed for clinical use include K-Sol (Cilco, Huntington, West Virginia), Chondroitin Sulfate Storage Medium (CSM), Dexsol, Optisol-GS (Chiron Ophthalmics Inc. Irvine, California), Chen Medium (Chen Laboratories, Phoenix, MD, https://jamanetwork.com/journals/jamaophthalmology/fullarticle/272206) and Likorol (Opsia Pharma, France). Other examples of corneal preservation solution include Life4° C. (Numedis, U.S.), Cornea Cold™, Kerasave (AL.CHI.MI.A. S.r.l.). Other examples of preservation solution include University of Wisconsin (UW) Solution and similar agents for liver and kidney cold storage. Optisol-GS is a widely used, commercially available media for the cold storage of corneas, and includes dextran, chondroitin sulfate, vitamins, and precursors of adenine triphosphate (adenosine, inosine, and adenine). In an embodiment, the corneal preservation solution can comprise dextran, chondroitin sulfate, or a combination thereof. In an embodiment, the corneal preservation solution comprises chondroitin sulfate.

The compound which results in activation of FOXO1 may be mixed with a physiological solution and/or a preservation solution prior to contacting the cell, tissue, or organ. The preservation solution can be commercially available, or can be a novel low temperature preservation solution as discussed herein. The composition comprising the compound which results in activation of FOXO1 may be prepared by directly dissolving the compound which results in activation of FOXO1 into the physiological solution and/or preservation solution to a concentration optimized for the cell, tissue, or organ. In an embodiment, the cell, tissue, or organ can be a cornea or corneal cell or a pancreatic islet or cell, preferably a cornea or corneal cell, even more preferably a corneal endothelial cell.

The concentration of the compound which results in activation of FOXO1 in the composition is a physiologically effective amount, which when administered to the cell, tissue or organ preserves the viability of the cell, tissue, or organ during cold storage. In an embodiment, the concentration of the compound which results in activation of FOXO1 analog in the composition is a physiologically effective amount, which when administered to the cell, tissue, or organ results in activation of the FOXO1 protein. In an embodiment, the cell, tissue, or organ can be a cornea or corneal cell or a pancreatic islet or cell, preferably a cornea or corneal cell. In an embodiment, the corneal cell is a corneal endothelial cell.

In an embodiment, the concentration of the cell permeable ceramide analog in the composition can be 0.1 micromolar (μM) to 100 μM, or 1 μM to 50 μM, or 1 μM to 25 μM, or 2 μM to 20 μM, or 5 μM to 15 μM.

In an embodiment, the concentration of the Apigenin in the composition can be 0.1 μM to 30 μM, or 0.1 μM to 20 μM, or 0.1 μM to 10 μM, or 0.1 μM to 5 μM.

The composition can further include a pharmaceutically acceptable additive or excipient. The pharmaceutically acceptable excipient, as used herein, refers to a non-active pharmaceutical ingredient (“API”) substance such as a disintegrator, a binder, a filler, and a lubricant used in formulating a pharmaceutical composition or product. Each of these substances is generally safe for administering to humans according to established governmental standards, including those promulgated by the United States Food and Drug Administration (“FDA”).

Examples of a disintegrator include agar-agar, algins, calcium carbonate, carboxymethylcellulose, cellulose, clays, colloid silicon dioxide, croscarmellose sodium, crospovidone, gums, magnesium aluminium silicate, methylcellulose, polacrilin potassium, sodium alginate, low substituted hydroxypropylcellulose, and cross-linked polyvinylpyrrolidone hydroxypropylcellulose, sodium starch glycolate, and starch, or a combination thereof, but is not limited thereto.

Examples of a binder include microcrystalline cellulose, hydroxymethyl cellulose hydroxypropylcellulose, or a combination thereof, but is not limited thereto.

Examples of a filler include calcium carbonate, calcium phosphate, dibasic calcium phosphate, tribasic calcium sulfate, calcium carboxymethylcellulose, cellulose, dextrin derivatives, dextrin, dextrose, fructose, lactitol, lactose, magnesium carbonate, magnesium oxide, maltitol, maltodextrins, maltose, sorbitol, starch, sucrose, sugar, xylitol, or a combination thereof, but is not limited thereto.

Examples of a lubricant include agar, calcium stearate, ethyl oleate, ethyl laureate, glycerin, glyceryl palmitostearate, hydrogenated vegetable oil, magnesium oxide, magnesium stearate, mannitol, poloxamer, glycols, sodium benzoate, sodium lauryl sulfate, sodium stearyl, sorbitol, stearic acid, talc, zinc stearate, or a combination thereof, but is not limited thereto.

The compound which results in activation of FOXO1 in the composition is used in methods that improve the viability of the cell, tissue, or organ during an extended period of cold storage. The composition can be used to pretreat the cell, organ or tissue prior to exposure to a low temperature environment. The composition can also be used to maintain the viability of the cell, organ, or tissue during storage in the low temperature environment. In an embodiment, the cell, tissue, or organ can be a cornea or corneal cell or a pancreatic islet or cell, preferably a cornea or corneal cell, even more preferably a corneal endothelial cell.

Disclosed herein is also a method of treating a cell, tissue, or organ to withstand exposure to a low temperature environment, the method comprising providing the cell, tissue, or organ to be exposed to the low temperature environment; and contacting the cell, tissue, or organ with a composition comprising an amount of a compound which results in activation of FOXO1 effective to enable the cell, tissue, or organ to withstand exposure to the low temperature.

Disclosed herein also is a method of preserving viability of a cell, tissue, or organ during exposure to a low temperature environment, the method comprising contacting the cell, tissue, or organ with a composition comprising an amount of a compound which results in activation of FOXO1 effective to preserve the viability of the cell, tissue, or organ; and exposing the cell, tissue, or organ to the low temperature environment.

In an embodiment, the methods disclosed herein also reduces damage of a cell, tissue, or organ when exposed to the low temperature environment.

In an embodiment, the cell, tissue, or organ can be a cornea or corneal cell or a pancreatic islet or cell, preferably a cornea or corneal cell. In an embodiment, the corneal cell is an endothelial cell, an epithelial cell, a keratocyte, or a combination thereof. The corneal cell is contained within an intact cornea. In an embodiment, the corneal cell is an endothelial cell and is contained within the corneal endothelium of the cornea.

In an embodiment, a method of treating a cell, tissue, or organ to withstand exposure to a low temperature environment comprises providing the cell, tissue, or organ to be exposed to the low temperature environment, and contacting the cell, tissue, or organ with a composition comprising an amount of a compound which results in activation of FOXO1 effective to enable the cell, tissue, or organ to withstand exposure to the low temperature. In an embodiment, disclosed herein also is a method of preserving viability of a cell, tissue, or organ, during exposure to a low temperature environment, the method comprising contacting the cell, tissue, or organ with a composition comprising an amount of compound which results in activation of FOXO1 effective to preserve the viability of the cell, tissue, or organ; and exposing the cell, tissue, or organ to the low temperature environment.

In an embodiment, the cell, tissue, or organ is a mammalian cell, tissue, or organ, which include neuronal cells, retinal cells, cornea, retina, skin, heart, lung, pancreas, kidney, liver, intestine, stem cells, blood, or any other cell, tissue, or organ that is suitable for transplantation. In an embodiment, the cell, tissue, or organ can be a cornea or corneal cell or a pancreatic islet or cell, preferably a cornea or corneal cell, even more preferably a corneal endothelial cell. The cornea is a transplantable tissue, which is removed from the eye of a donor and stored at a low temperature for a period of time prior to transplantation.

In the disclosed methods, the contacting of the cell, tissue, or organ with the composition can occur prior to exposure of the cell, tissue, or organ to the low temperature environment, during the exposure of the cell, tissue, or organ to the low temperature environment, or a combination thereof. In an embodiment, the contacting of the cell, tissue, or organ with the composition occurs prior to exposure of the cell, tissue, or organ to the low temperature environment.

In an embodiment, the cell, tissue, or organ is contacted (pretreated) with the composition before removal of the cell, tissue, or organ from the donor, after removal of the cell, tissue, or organ from the donor, or a combination thereof. In an embodiment, the cell, tissue or organ is a cornea or a corneal cell, and the contacting of the cornea or corneal cell with the composition can occur prior to removal of the cornea from the eye of the donor, after the removal of the cornea from the eye of the donor, or a combination thereof. In each case, the contacting occurs prior to the initiation of cold storage.

In an embodiment, the cell, tissue, or organ is a cornea which is contacted (pretreated) with the composition before removal of the cornea from the eye of the donor. The composition comprising the compound which results in activation of FOXO1 is injected into the anterior chamber of the eye, which is the aqueous humor filled space in the front part of the eye between the cornea and the iris. In the anterior chamber, the composition contacts endothelial cells within the corneal endothelium at the posterior surface of the cornea. After a defined period of time, the cornea is removed from the donor eye.

In an embodiment, the cornea is contacted (pretreated) with the composition after removal of the cornea from the eye of the donor. The cornea is removed from the eye of the donor and placed in a vessel containing the composition for a defined period of time.

In an embodiment, the defined period of time that the cell, tissue, or organ can be pretreated with the composition is 5 minutes to 240 minutes, 10 minutes to 150 minutes, 20 minutes to 120 minutes, 20 minutes to 90 minutes, or 45 minutes to 90 minutes, or 45 minutes to 60 minutes. In an embodiment, the contacting time is 20 minutes to 90 minutes. The cell, tissue, or organ may be pretreated with the composition comprising the compound which results in activation of FOXO1 at a temperature of about 22° C. to 37° C., for example, 25° C. to 37° C.

Following pretreatment of the cell, tissue, or organ with the composition, the cell, tissue, or organ is placed in a medium suitable for maintaining (storing) the cell, tissue or organ in the low temperature environment, and then placed in the low temperature environment. In an embodiment, the medium is a preservation solution. In an embodiment, the preservation solution can include the compound which results in activation of FOXO1, which has been pre-added.

In an embodiment, the cell, tissue or organ is a cornea or corneal cell, and the cornea can be stored in a corneal preservation solution (commercially known or discussed herein), optionally with the compound which results in activation of FOXO1 pre-added. In an embodiment, the cornea or corneal cell is maintained in the low temperature environment in the presence of the composition comprising the compound which results in activation of FOXO1.

The cell, tissue, or organ can be maintained in the low temperature environment in the presence of the preservation solution for a period of 1 day (24 hours) to 56 days (8 weeks). In an embodiment, the cell, tissue, or organ is a cornea or corneal cell, and the cornea can be maintained in the low temperature environment in the presence of the corneal preservation solution for a period of 1 day (24 hours) to 42 days (6 weeks), 1 day to 35 days, 5 days to 35 days, 10 days to 35 days, 14 days to 35 days, 10 days to 28 days, or 14 days to 28 days. In an embodiment, the exposure of the cell, tissue, or organ to a low temperature environment comprises storage at a temperature of 2° C. to 8° C. for a period of at least one week, preferably for at least 1 week to 5 weeks, more preferably for at least 1 week to 4 weeks. The cell, tissue or organ can be maintained in the low temperature environment in the presence of the preservation solution for a period of at least 2 weeks, at least 3 weeks, at least 4 weeks, or at least 5 weeks without significant loss in the viability of the cell, tissue, or organ.

In an embodiment, cell, tissue, or organ is a cornea or corneal cell. In an embodiment, the corneal cell is an endothelial cell present in an intact corneal endothelium. The corneal endothelium has a viability of at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, or at least 99% after storage at a temperature of 0° C. to 8° C. for a period of 4 weeks. In an embodiment, the maintenance of the cornea at a temperature of 0° C. to 8° C. for a period of 4-5 weeks results in preservation of 80% to 100%, or 85% to 100%, or 90% to 100%, or 95% to 100% viability of the endothelial cells in the corneal endothelium.

Also disclosed is use of a composition comprising a compound which activates FOXO1 protein as discussed herein in the cell, tissue, or organ to treat or preserve viability of the cell, tissue, or organ to withstand exposure to a low temperature environment.

Also disclosed is use of a composition comprising a compound which activates FOXO1 protein as discussed herein for the manufacture of a medicament to treat or preserve viability of a cell, tissue or organ to withstand exposure to a low temperature environment.

In an embodiment, the uses disclosed herein also reduces damage of a cell, tissue, or organ when exposed to the low temperature environment.

Also disclosed herein is a novel preservation solution for preservation of the cell, tissue or organ comprising combination of amino acids, vitamin preparation, inorganic salt, and other components. In an embodiment, the novel preservation solution is for cornea preservation. In an embodiment, the preservation solution is calculated per 1 L, including the following components:

### Amino Acid:

Alanine 1.5-2.2 mg
Arginine 75-93 mg
Asparagine 14-17 mg
Cysteine 0.9-1.1 mg
Glycine 27-33 mg
Glutamine 180-220 mg
Histadine 28-34 mg
Isoleucine 94-120 mg
Leucine 94-120 mg
Lysine 100-130 mg
Methionine 27-33 mg
Phenylalanine 59-73 mg
Proline 7-8.5 mg
Serine 36-46 mg
Threonine 85-105 mg
Tryptophan 14-18 mg
Tyrosine 60-80 mg
Valine 84-105 mg

### Vitamins:

Choline 4-5.2 mg
D-Calcium pantothenate 3-4.5 mg
Pantothenic acid (Vitamin B5) 0.9-1.1 mg
Folic acid 4-5 mg
Niacinamide 4-5 mg
Pyridoxal (Vitamin B6) 4-5 mg
Riboflavin (vitamin B2) 0.09-0.11 mg
Thiamine (Vitamin B1) 5-6.5 mg
Vitamin B12 1-1.5 mg

### Inorganic Salt:

CaCl₂ 170-220 mg
Fe(NO₃)₃ 50-70 mg
KCl 360-440 mg
NaHCO₃ 66-85 mg
NaCl 4300-5300 mg
NaH₂PO₄ 120-160 mg
MgCl₂ 69-85 mg
ZnSO₄ 97-120 mg

### Other Components:

Adenosine 1.3-1.7 mg
Chondroitin sulfate 22000-28000 mg
Glucose 4000-5000 mg
Dextran 9000-11000 mg
Gentamicin 90-110 mg
Inosine 9-12 mg
Inositol 10-14 mg
Phenol red 330-420 mg
Pyridoxal Hydrochloride 0.9-1.1 mg
MES monohydrate 220-280 mg
MOPS buffer 9000-11000 μm
HEPES buffer 1800-2200 μm
Sodium pyruvate 0.9-1.2 mg
2-mercaptoethanol 3.4-4.3 mg.

In an embodiment, the preservation solution has a pH of 7.3±2 and an osmotic pressure of 300±50 mOsm.

In an embodiment, the preservation solution discussed herein can prolong the storage life of a cell, tissue, or organ from about 12 days to about 28-35 days. In an embodiment, cell, tissue, or organ is a mammalian cell, tissue, or organ, which include neuronal cells, retinal cells, cornea, retina, skin, heart, lung, pancreas, kidney, liver, intestine, stem cells, blood, or any other cell, tissue, or organ that is suitable for transplantation. In an embodiment, the cell, tissue, or organ can be a cornea or corneal cell or a pancreatic islet or cell, preferably a cornea or corneal cell, even more preferably a corneal endothelial cell. It was observed that the cornea after 28 days of cold storage was still able to be successfully transplanted into a rat recipient.

In an embodiment, the disclosed preservation solution further comprises a protease inhibitor mixture (Pi) (which is described in WO2019/040359A1) and/or a compound which results in activation of FOXO1 as discussed herein.

In an embodiment, the compound which results in activation of FOXO1 is a cell permeable ceramide analog, Apigenin, N-EM (deSumoylation inhibitor), resveratrol, or Leptomycin B (LMB) as discussed herein. N-EM (deSumoylation inhibitor) and resveratrol induce FOXO1 translocation to the nucleus. Leptomycin B (LMB) is a nuclear export inhibitor of exportin-1/CRM1 which causes FOXO1 to accumulate in the nucleus. In an embodiment, the compound can be a cell permeable ceramide analog or Apigenin as discussed herein.

In an embodiment, the compound which results in activation of FOXO1 is a cell permeable ceramide analog, wherein the cell permeable ceramide analog comprises a compound represented by Formula 1,

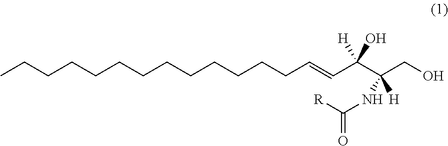

wherein R is a C1 to C10 alkyl group.

In an embodiment, the cell permeable analog comprises a compound represented by Formula 2, also known as C6 ceramide.

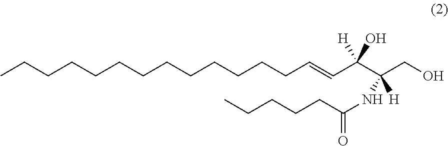 [SMILES: CCCCCCCCCCCCC/C=C/[C@@H](O)[C@H](CO)NC(=O)CCCCC]

In an embodiment, the concentration of the cell permeable ceramide analog in the preservation solution can be 0.1 to 100 μM/μL, or 1 μM to 50 μM/μL, or 1 to 25 μM/μL, or 5 to 20 μM/μL, or 5 to 15 μM/μL.

In an embodiment, the compound which results in activation of FOXO1 is Apigenin. In an embodiment, the concentration of the Apigenin in the preservation solution can be 0.1 to 30 μM/μL, or 0.1 to 20 μM/μL, or 0.1 to 10 μM/μL, or 0.1 to 5 μM/μL.

In an embodiment, the components of the protease inhibitor mixture (Pi) and their concentrations for the novel preservation solution are respectively as follows:
aspartic protease inhibitor (e.g., Pepstatin, Pepstatin A): 1-20 μM;
serine and cysteine protease inhibitor (e.g., Leupeptin): 2-40 μM.

In an embodiment, the protease inhibitor mixture Pi further comprises the at least one of the following components and concentrations for the novel preservation solution:
metallo-protease inhibitors (e.g., Betadine, Bestatin): 5-50 μM;
cysteine protease inhibitor (e.g., E-64): 1.5-30 μM;
serine protease inhibitor (e.g., Aprotinin): 0.08-2 μM;
AEBSF (4-(2-aminoethyl) benzenesulfonyl fluoride hydrochloride): 10-100 μM.

Preferably, the protease inhibitor mixture (Pi) contains the following components and concentrations for the novel preservation solution:
pepstatin 1 μM;
leupeptin 2 μM;
bestatin 5 μM;
E-64 1.5 μM;
aprotinin 0.08 μM;
AEBSF 100 μM.

The disclosed preservation solution is used in methods that improve the viability of the cell, organ, or tissue during an extended period of cold storage. The disclosed preservation solution can be used to pretreat the cell, organ or tissue prior to exposure to a low temperature environment. The novel preservation solution can also be used to maintain the viability of the cell, tissue, or organ during storage in the low temperature environment.

Disclosed herein is a method of treating a cell, organ, or tissue to withstand exposure to a low temperature environment, the method comprising providing the cell, tissue, or organ to be exposed to the low temperature environment; and contacting the cell, organ, or tissue with the disclosed preservation solution discussed herein to enable the cell, organ, or tissue to withstand exposure to the low temperature.

Disclosed herein also is a method of preserving viability of a cell, organ, or tissue during exposure to a low temperature environment, the method comprising contacting the cell, organ or tissue, with the disclosed preservation solution as discussed herein to preserve the viability of the cell, organ, or tissue; and exposing the cell, organ or tissue to the low temperature environment.

In an embodiment, the methods disclosed herein also reduces damage of a cell, organ, or tissue when exposed to the low temperature environment.

In an embodiment, cell, tissue, or organ is a mammalian cell, tissue, or organ, which include neuronal cells, retinal cells, cornea, retina, skin, heart, lung, pancreas, kidney, liver, intestine, stem cells, blood, or any other cell, tissue, or organ that is suitable for transplantation. In an embodiment, the cell, tissue, or organ can be a cornea or corneal cell or a pancreatic islet or cell, preferably a cornea or corneal cell. In an embodiment, the corneal cell is an endothelial cell, an epithelial cell, a keratocyte, or a combination thereof. The corneal cell is contained within an intact cornea. In an embodiment, the corneal cell is an endothelial cell and is contained within the corneal endothelium of the cornea.

In an embodiment, a method of treating a cell, organ, or tissue to withstand exposure to a low temperature environment comprises providing the cell, organ, or tissue to be exposed to the low temperature environment, and contacting the cell, organ, or tissue with the novel preservation solution discussed herein effective to enable the cell, organ, or tissue to withstand exposure to the low temperature. In an embodiment, disclosed herein also is a method of preserving viability of a cell, organ, or tissue during exposure to a low temperature environment, the method comprising contacting the cell, organ, or tissue with the novel preservation solution discussed herein effective to preserve the viability of the cell, organ, or tissue; and exposing the cell, organ, or tissue to the low temperature environment.

In an embodiment, the contacting of the cell, tissue, or organ with the novel preservation solution and/or a composition comprising a compound which results in activation of FOXO1 can occur prior to exposure of the cell, tissue, or organ to the low temperature environment. The contacting of the cell, tissue, or organ with the novel preservation solution or composition can occur prior to removal of the cell, tissue, or organ from the donor, after the removal of the cell, tissue, or organ from the donor, or a combination thereof. In each case, the contacting occurs prior to the initiation of cold storage.

The cornea is a transplantable tissue, which is removed from the eye of a donor and stored at a low temperature for a period of time prior to transplantation. In the disclosed methods, the contacting of the cornea or corneal cell with the novel preservation solution can occur prior to exposure of the cornea to the low temperature environment, during the exposure of the cornea to the low temperature environment, or a combination thereof.

In an embodiment, the cornea is contacted (pretreated) with the novel preservation solution and/or composition before removal of the cornea from the eye of the donor. The novel preservation solution and/or composition comprising the compound which results in activation of FOXO1 is injected into the anterior chamber of the eye, which is the aqueous humor filled space in the front part of the eye between the cornea and the iris. In the anterior chamber, the composition contacts endothelial cells within the corneal endothelium at the posterior surface of the cornea. After a defined period of time, the cornea is removed from the donor eye.

In an embodiment, the cornea is contacted (pretreated) with the novel preservation solution and/or composition after removal of the cornea from the eye of the donor.

The cornea is removed from the eye of the donor and placed in a vessel containing the novel preservation solution and/or composition for a defined period of time.

In an embodiment, the cell, tissue, or organ can be pretreated with the novel preservation solution and/or composition for a period of 5 minutes to 240 minutes, 10 minutes to 150 minutes, 20 minutes to 120 minutes, 20 minutes to 90 minutes, or 45 minutes to 90 minutes, or 45 minutes to 60 minutes. In an embodiment, the contacting time is 20 minutes to 90 minutes.

The cell, tissue, or organ may be pretreated with the novel preservation solution and/or composition comprising the compound which results in activation of FOXO1 at a temperature of 22° C. to 37° C., for example, 25° C. to 37° C.

In an embodiment, the cell, tissue, or organ is a cornea or corneal cell, and following pretreatment of the cornea with the novel preservation solution and/or composition, the cornea is placed in a medium suitable for maintaining (storing) the cornea in the low temperature environment, and then placed in the low temperature environment. The cornea can be stored in the novel corneal preservation solution discussed herein. In an embodiment, the novel corneal preservation solution can include the compound which results in activation of FOXO1 and/or Pi. In an embodiment, the cornea or corneal cell is maintained in the low temperature environment in the presence of the novel preservation solution comprising the compound which results in activation of FOXO1 and/or Pi.

The cell, tissue, or organ can be maintained in the low temperature environment in the presence of the novel preservation solution for a period of 1 day (24 hours) to 42 days (6 weeks), 1 day to 35 days, 5 days to 35 days, 10 days to 35 days, 14 days to 35 days, 10 days to 28 days, or 14 days to 28 days. In an embodiment, the exposure of the cell, tissue, or organ to a low temperature environment comprises storage at a temperature of 2° C. to 8° C. for a period of at least one week, preferably for at least 1 week to 5 weeks, more preferably for at least 1 week to 4 weeks. The cell, tissue, or organ can be maintained in the low temperature environment in the presence of the novel preservation solution for a period of at least 2 weeks, at least 3 weeks, at least 4 weeks, or at least 5 weeks, without significant loss in the viability of the cell, tissue, or organ.

In an embodiment, the cell, tissue, or organ is a corneal cell, preferably an endothelial cell present in an intact corneal endothelium. The corneal endothelium has a viability of at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, or at least 99% after storage at a temperature of 0° C. to 8° C. for a period of 4 weeks. In an embodiment, the maintenance of the cornea at a temperature of 0° C. to 8° C. for a period of 4 weeks results in preservation of 80% to 100%, or 85% to 100%, or 90% to 100%, or 95% to 100% viability of the endothelial cells in the corneal endothelium.

Also disclosed is use of the novel preservation solution as discussed herein in the cell, organ, or tissue to treat or preserve viability of the cell, tissue, or organ to withstand exposure to a low temperature environment. Also disclosed is use of the novel preservation solution as discussed herein for the manufacture of a medicament to treat or preserve viability of a cell, tissue, or organ to withstand exposure to a low temperature environment. In an embodiment, the uses disclosed herein also reduces damage of a cell, tissue, or organ when exposed to the low temperature environment.

This disclosure is further illustrated by the following examples, which are non-limiting.

### EXAMPLES

### Example 1

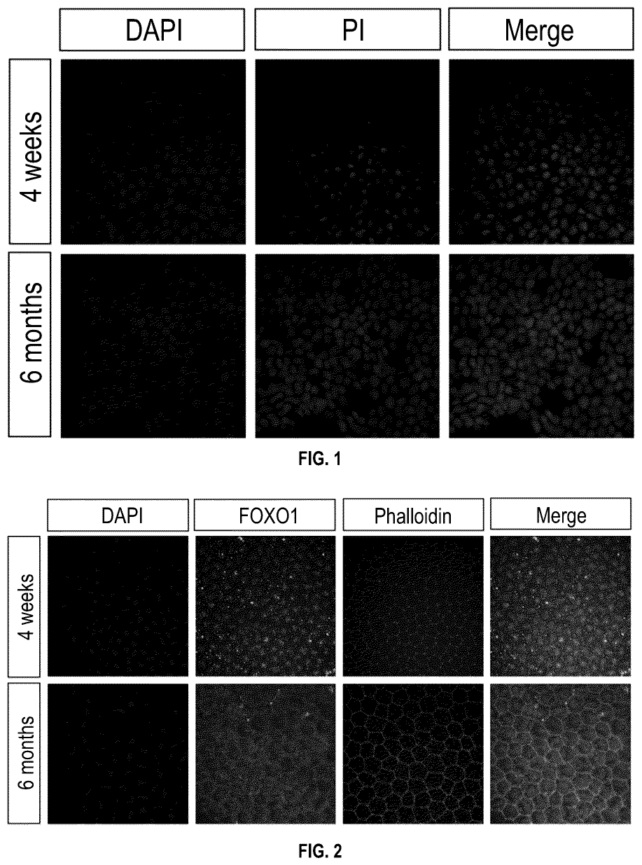

This example demonstrates that activation of FOXO1 provides a young cornea with better cold-adaptation. The cornea of a rat at 4 weeks of age and the cornea of a rat at 6 months of age are removed and stored in standard Optisol™ corneal preservation solution for 3 weeks at 4° C. As a result, as shown in FIG. 1, corneal endothelial cells were found to demonstrate increased survival/less mortality for the 4-week-old rats compared to 6-month-old rats, indicating that corneal tissue of young individuals have better cold-adaptation ability.

By immunofluorescent staining, it was found (FIG. 2) that FOXO1 transcription factor translocated from the cytosol (“inactive”) into the cell nucleus (“active”) in 4 weeks old fresh cornea, while FOXO1 was mainly present in the cytoplasm in 6 months old cornea. This again indicates that FOXO1 may be associated with a better cold-acclimation ability of the cornea of young rats.

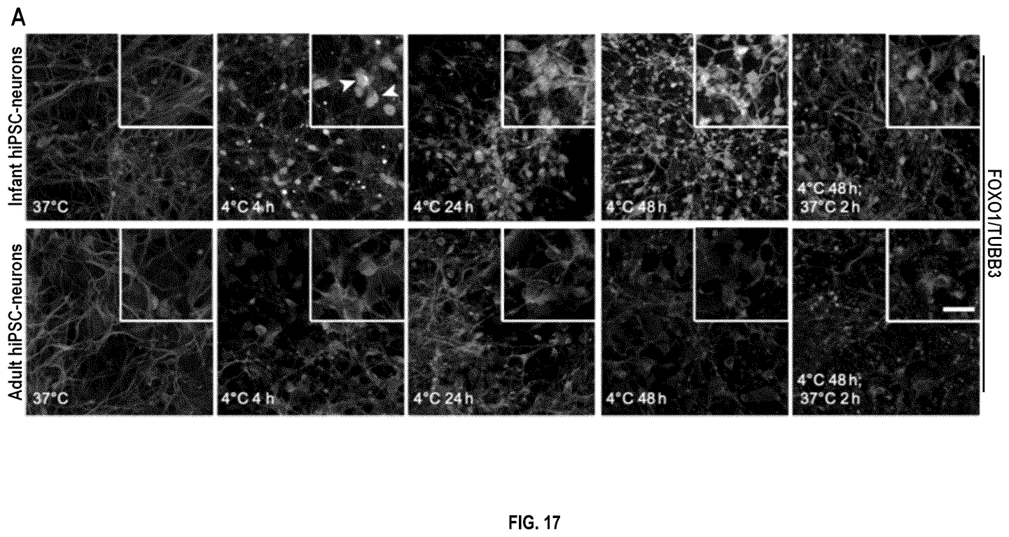

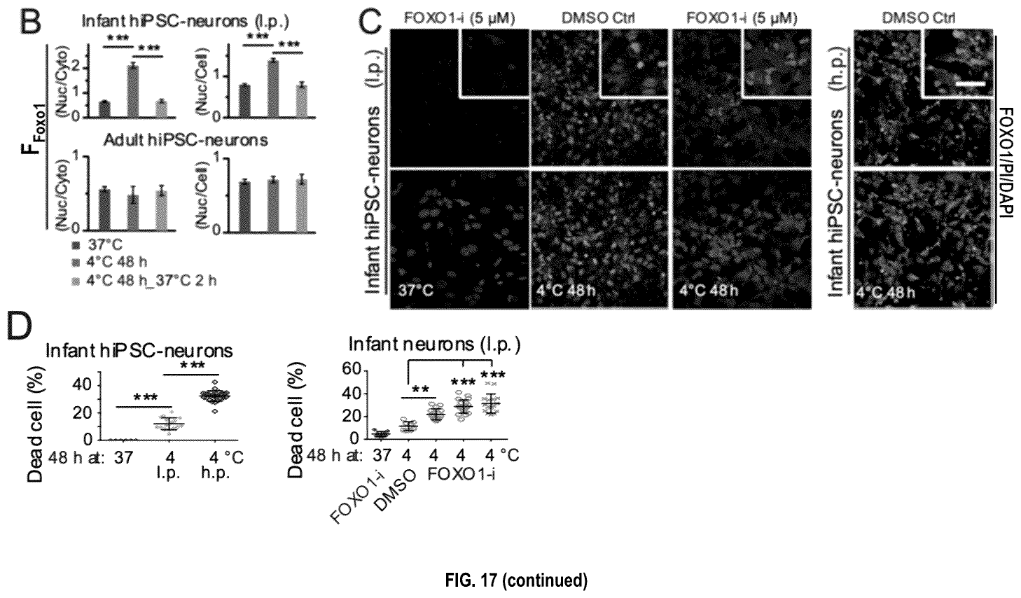

It was seen in torpid ground squirrels (TLGS) that when environmental temperature drops from 37° C. to 4° C., transcription factor FOXO1 will translocate from the cytosol (‘inactive’) into the cell nucleus (‘active’) in TLBS iPSC-neurons and young human iPSC-neurons, but not in adult human iPSC-neurons (FIG. 16A-16B and FIG. 17A-17D). If FOXO1 is inhibited by drug, or naturally in adult human cells, then the same duration of 4° C. incubation will result in significantly higher cell deaths.

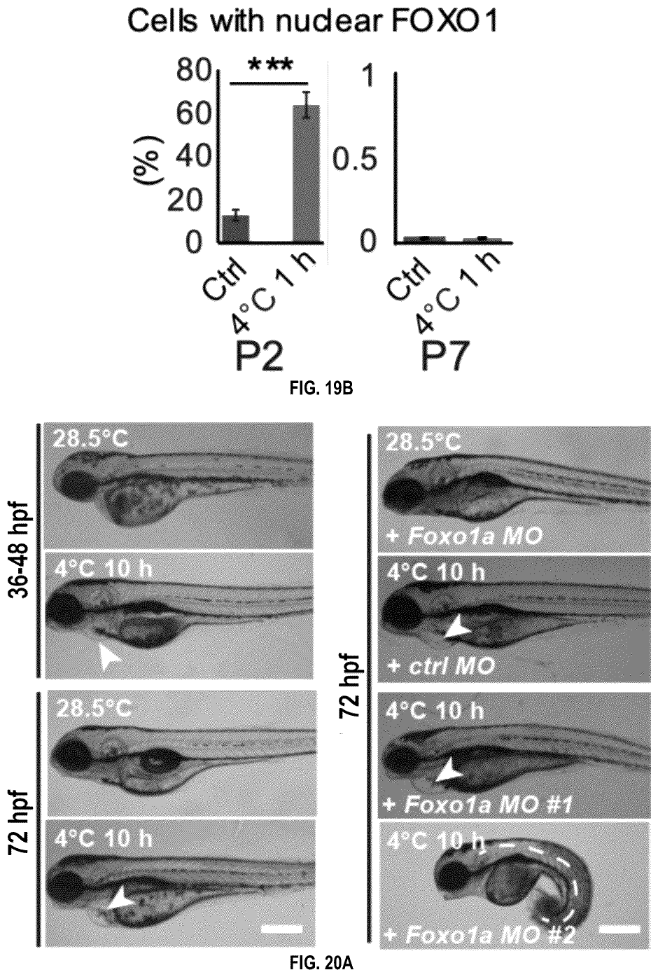

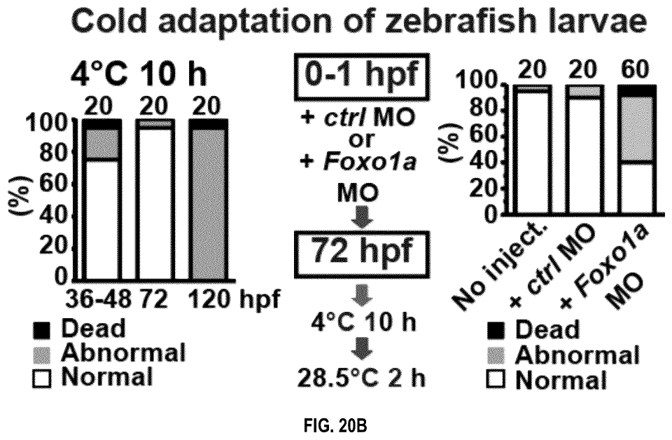

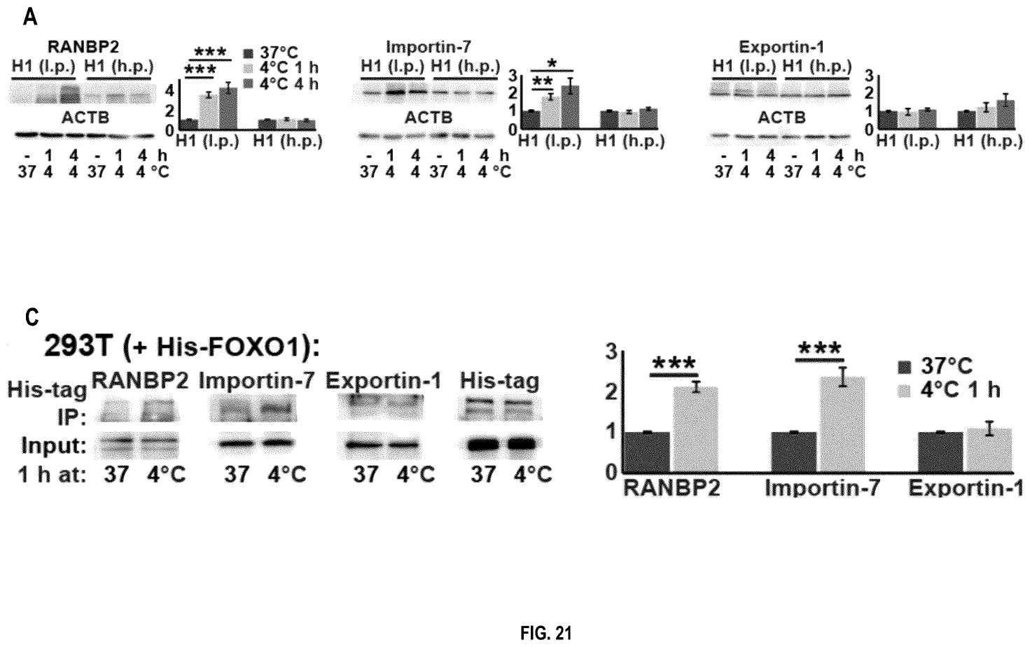

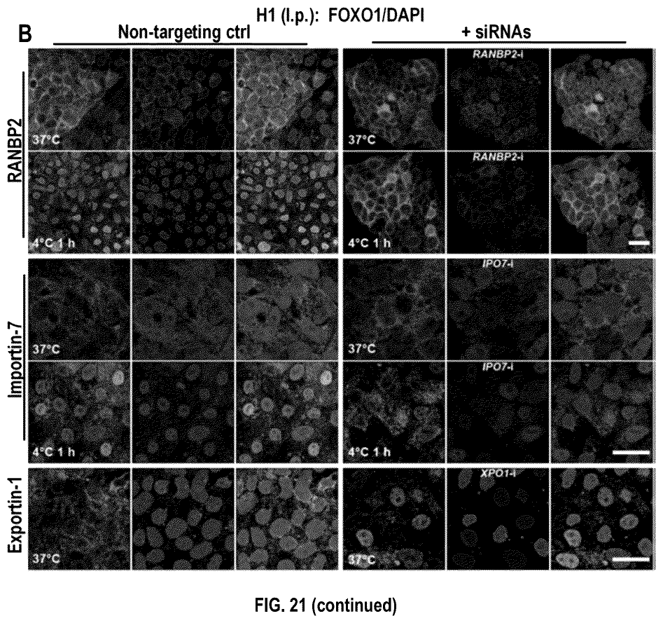

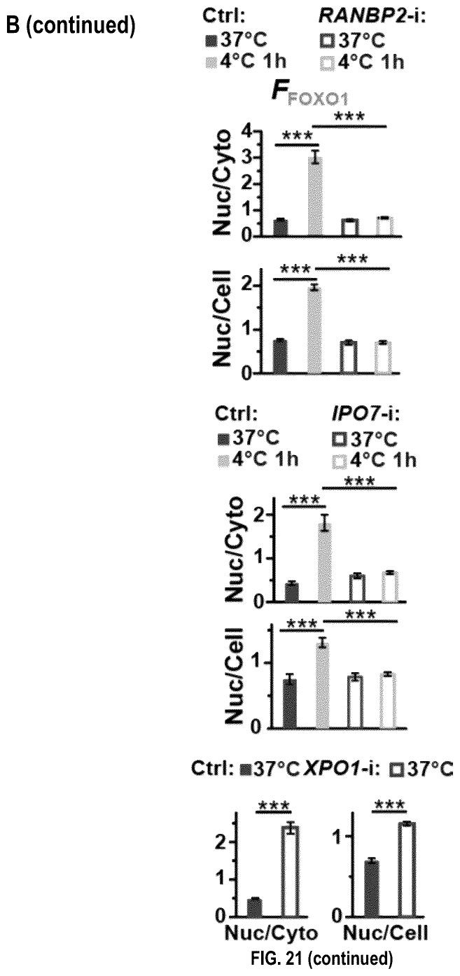

Also, the temperature-sensitive feature of FOXO1 is conserved in various cold intolerant species. See FIGS. 18, 19A-B, and 20A-B. The FOXO1 nuclear transport is regulated by RANBP2/Importin-7/Exportin-1; RANBP2 is a SUMO (Small Ubiquitin-like Modifiers) E3 ligase. Adding SUMOyaltion inhibitors inhibits FOXO1 nuclear entry; adding deSUMOylation inhibitor N-Ethylmaleimide enables longer term cold storage of human and mouse pancreatic islets. FIG. 21A-C shows that cold-induced FOXO1 nuclear entry is enabled by SUMO E3 ligase RANBP2 and transporter protein Importin-7, and inhibited by transporter protein Exportin-1. Deteriorated functions of RANBP2 and Importin-7 may be the reason of the repression of FOXO1 nuclear entry following cold stress in older H1 cells.

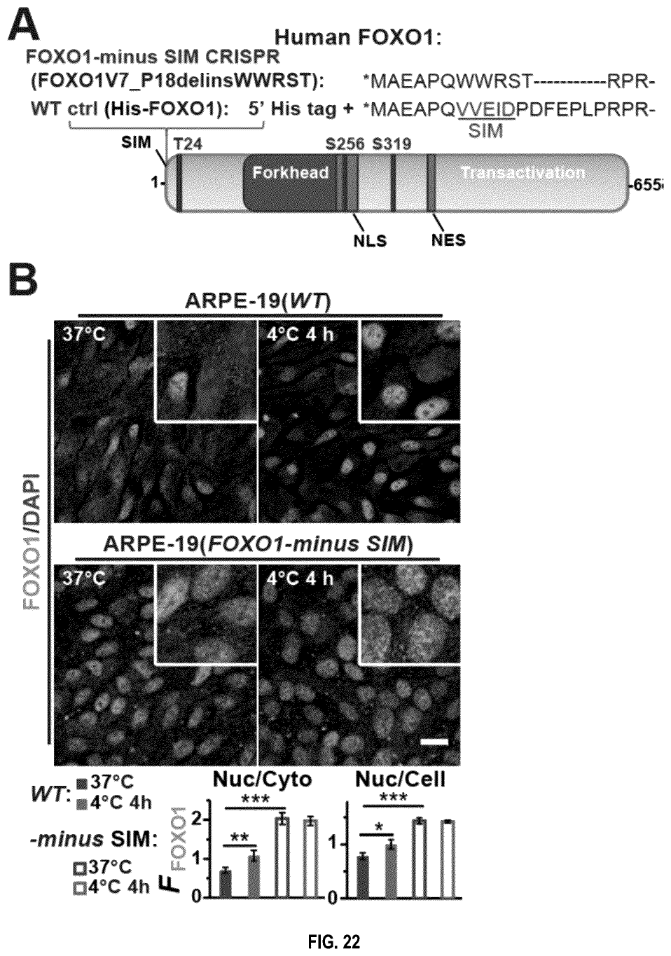

FIG. 22A-B indicates that cold-induced FOXO1 nuclear entry is also determined by a key SUMO-interacting motif (SIM) on the N-terminal of the FOXO1 protein; if the SIM motif is mutated, FOXO1 proteins will accumulate in cell nucleus at normal condition; 2) Therefore, it is potentially possible to design drugs or polypeptides to interact with FOXO1 SIM prior to cell cold exposure, hence ‘activating’ transport of FOXO1 proteins into the cell nucleus and enhance cell cold survival.

### Example 2

Donor sources for corneal transplants are mainly adults and the elderly, and the question is whether adult corneas can obtain cold-adaptation of the corneas of young individuals by activating FOXO1. The instant inventors demonstrate that C6 ceramide (abbreviated as C6) and Apigenin can activate adult rat cornea FOXO1.

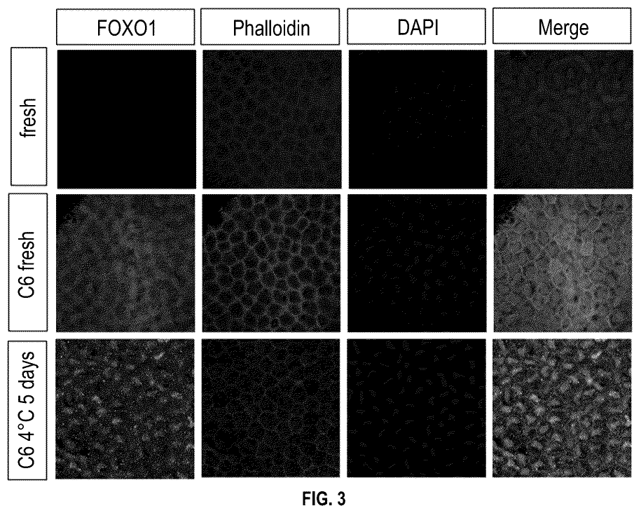

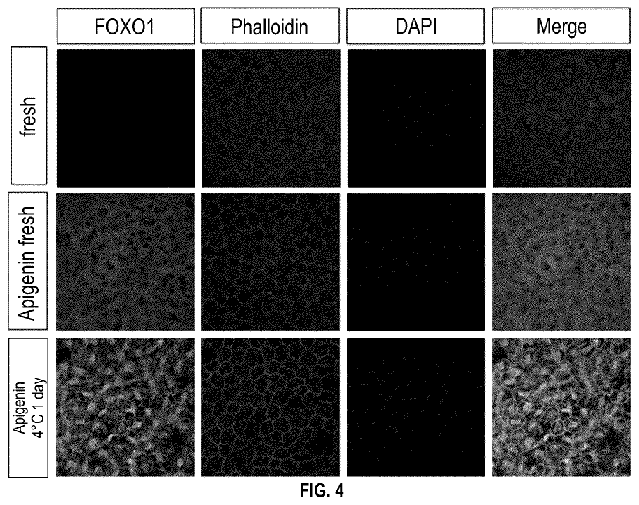

The inventors injected two drugs, C6 ceramide (C6 at 20 μM/μL concentration, in goat serum solvent) and Apigenin (at 4 μM/μL concentration, in goat serum solvent) into the anterior chamber of the eyes of 6-month-old rats, and found that the corneal endothelial cells of the rat activate FOXO1 nucleus entry, and that nucleus entry signal was enhanced after cold stimulation after C6 injection (FIG. 3). The injection of Apigenin did not cause FOXO1 to enter nucleus. The nuclear entering signal activated FOXO1 to enter the nucleus after cold stimulation, and the weak nuclear entering effect is still maintained after rewarming (FIG. 4).

Therefore, the inventors found that the two drugs of C6 ceramide and Apigenin are useful for activating FOXO1 into the nucleus and enhancing the cold adaptation capability of the cornea of an adult rat.

### Example 3—Novel Corneal Preservation Solution Formulations

The inventor adjusted the components of the preservation solution according to the metabolic characteristics in the hibernation period and mainly used polar neutral amino acid, basic amino acid and water-soluble vitamin so as to meet the normal physiological requirements of cells in the cold preservation period. The composition of the improved corneal preservation solution is shown in table 1:

TABLE 1
improved corneal preservation solution (MCM) formulation

| MCM | mg/L | μM |
|---|---|---|
| amino acid | | |
| alanine | 2 | 22 |
| arginine | 84.1 | 483 |
| asparagine | 16 | 15.5 |
| cysteine | 1 | 7.7 |
| glycine | 30 | 400 |
| glutamine | 200 | 1368.46 |
| histidine | 31 | 200 |
| isoleucine | 105.2 | 802 |
| leucine | 105.2 | 802 |
| lysine | 116.66 | 798 |
| methionine | 30 | 201 |
| phenylalanine | 66 | 400 |
| proline | 7.7 | 67 |
| serine | 42 | 400 |
| threonine | 95 | 798 |
| tryptophan | 15.93 | 78 |
| tyrosine | 72.11 | 398 |
| valine | 94 | 803 |
| vitamins | | |
| choline | 4.7 | 39 |
| D-Calcium | 3.8 | 8 |
| pantothenate | | |
| Pantothenic acid, | 1 | 4.2 |
| vitamin B5 | | |
| folic acid | 4.5 | 10.3 |
| niacinamide | 4.6 | 38 |
| Pyridoxal, vitamin B6 | 3.4 | 20 |
| Riboflavin, vitamin | 0.1 | 1.3 |
| B2 | | |
| Thiamine, vitamin B1 | 5.9 | 12 |
| Vitamin B12 | 1.36 | 1.2 |
| Inorganic salt | | |
| CaCl₂ | 199.8 | 1800 |
| Fe(NO₃)₃ | 60.5 | 0.25 |
| KCl | 400 | 5360 |
| NaHCO₃ | 73.9 | 880 |
| NaCl | 4792 | 82000 |
| NaH₂PO₄ | 141.3 | 906 |
| MgCl₂ | 77.3 | 812 |
| ZnSO₄ | 108.2 | 0.67 |
| other | | |
| adenosine | 1.5 | 5.6 |
| chondroitin sulfate | 25000 | on. |
| glucose | 4504 | 25000 |
| dextran | 10000 | 40000 |
| gentamicin | 100 | 182.6 |
| inosine | 10.73 | 40 |
| inositol | 12 | 44.7 |
| Phenol red | 376.4 | 20 |
| Pyridoxal | 1 | 4.9 |
| hydrochloride | | |
| MES monohydrate | 250 | 1172.3 |
| MOPS buffer | 2092.6 | 10000 |
| HEPES buffer | 476.6 | 2000 |
| Sodium pyruvate | 1.1 | 10 |
| 2-mercaptoethanol | 3.87 | 49.5 |
| pH = 7.2 | | |
| Osmotic pressure is | | |
| 300 ± 20 mOsm | | |

### Example 4—Novel Corneal Preservation Solution Formulation

The composition of the novel cornea preserving fluid of this example is shown in Table 2.

TABLE 2
novel cornea preservative fluid (MCM) formulation

| MCM | mg/L |
|---|---|
| amino acid | |
| alanine | 1.5 |
| arginine | 93 |
| asparagine | 17 |
| cysteine | 0.9 |
| glycine | 27 |
| glutamine | 180 |
| histidine | 34 |
| isoleucine | 94 |
| leucine | 94 |
| lysine | 130 |
| methionine | 33 |
| phenylalanine | 73 |
| proline | 7 |
| serine | 36 |
| threonine | 85 |
| tryptophan | 14 |
| tyrosine | 60 |
| valine | 84 |
| vitamins | |
| choline | 4 |
| D-Calcium pantothenate | 3 |
| Pantothenic acid, vitamin B5 | 1.1 |
| folic acid | 5 |
| niacinamide | 5 |
| Pyridoxal, vitamin B6 | 4 |
| Riboflavin, vitamin B2 | 0.09 |
| Thiamine, vitamin B1 | 6.5 |
| Vitamin B12 | 1.5 |
| Inorganic salt | |
| CaCl₂ | 220 |
| Fe(NO₃)₃ | 70 |
| KCl | 360 |
| NaHCO₃ | 85 |
| NaCl | 4300 |
| NaH₂PO₄ | 160 |
| MgCl₂ | 69 |
| ZnSO₄ | 120 |
| other | |
| adenosine | 1.7 |
| chondroitin sulfate | 28000 |
| glucose | 4000 |
| dextan | 11000 |
| gentamicin | 110 |
| inosine | 9 |
| inositol | 10 |
| Phenol red | 330 |
| Pyridoxal hydrochloride | 1.1 |
| MES monohydrate | 280 |
| MOPS buffer | 9000 μM |
| HEPES buffer | 1800 μM |
| Sodium pyruvate | 1.2 |
| 2-mercaptoethanol | 3.4 |
| pH = 7.4 | |
| Osmotic pressure is300 ± 20 mOsm | |

### Example 5—Novel Corneal Preservation Solution Formulation

The composition of the novel cornea preserving fluid of this example is shown in Table 3.

TABLE 3
novel cornea preservative fluid (MCM) formulation

| MCM | mg/L |
|---|---|
| amino acid | |
| alanine | 2.2 |
| arginine | 75 |
| asparagine | 14 |
| cysteine | 1.1 |
| glycine | 33 |
| glutamine | 220 |
| histidine | 28 |
| isoleucine | 120 |
| leucine | 120 |
| lysine | 100 |
| methionine | 27 |
| phenylalanine | 59 |
| proline | 8.5 |
| serine | 46 |
| threonine | 105 |
| tryptophan | 18 |
| tyrosine | 80 |
| valine | 105 |
| vitamin | |
| choline | 5.2 |
| D-Calcium pantothenate | 4.5 |
| Pantothenic acid, vitamin B5 | 0.9 |
| folic acid | 4 |
| niacinamide | 4 |
| pyridoxal, vitamin B6 | 5 |
| Riboflavin, vitamin B2 | 0.11 |
| Thiamine, vitamin B1 | 5 |
| Vitamin B12 | 1 |
| Inorganic salt | |
| CaCl₂ | 170 |
| Fe(NO₃)₃ | 50 |
| KCl | 440 |
| NaHCO₃ | 66 |
| NaCl | 5300 |
| NaH₂PO₄ | 120 |
| MgCl₂ | 85 |
| ZnSO₄ | 97 |
| other | |
| adenosine | 1.3 |
| chondroitin sulfate | 22000 |
| glucose | 5000 |
| dextran | 9000 |
| gentamicin | 90 |
| inosine | 12 |
| inositol | 14 |
| Phenol red | 420 |
| Pyridoxal hydrochloride | 0.9 |
| MES monohydrate | 220 |
| MOPS buffer | 11000 μM |
| HEPES buffer | 2200 μM |
| Sodium pyruvate | 0.9 |
| 2-mercaptoethanol | 4.3 |
| pH = 6.8 | |
| Osmotic pressure is 300 ± 20 mOsm | |

### Example 6—Novel Cold Corneal Preservation Strategy

A novel corneal preservation solution is prepared according to the novel corneal preservation solution formula as discussed herein, and an optimal preservation strategy is adjusted by using Apigenin or C6. The specific process is as follows:

(1) C6

After injection of 0.5 μL C6 solution (10 μM/μL in goat serum solvent) into the anterior chamber of the eye through the limbal stroma. After 90 minutes, the cornea was taken and cold stored in a corneal preservation solution. After cold storage for 3 weeks and 4 weeks, the cold storage results were evaluated by immunofluorescence staining.

The corneal preservation solution of this example is the novel corneal preservation solution prepared in Example 3, with 20 μM C6 and the protease inhibitor mixture Pi (as described in WO2019/040359A1) added, and the final concentrations of the components in the protease inhibitor mixture Pi in the cold preservation solution are respectively: pepstatin 1 μM; leupeptin 2 μM; bestatin 5 μM; E-641 0.5 μM; aprotinin 0.08 μM; AEBSF 100 μM.

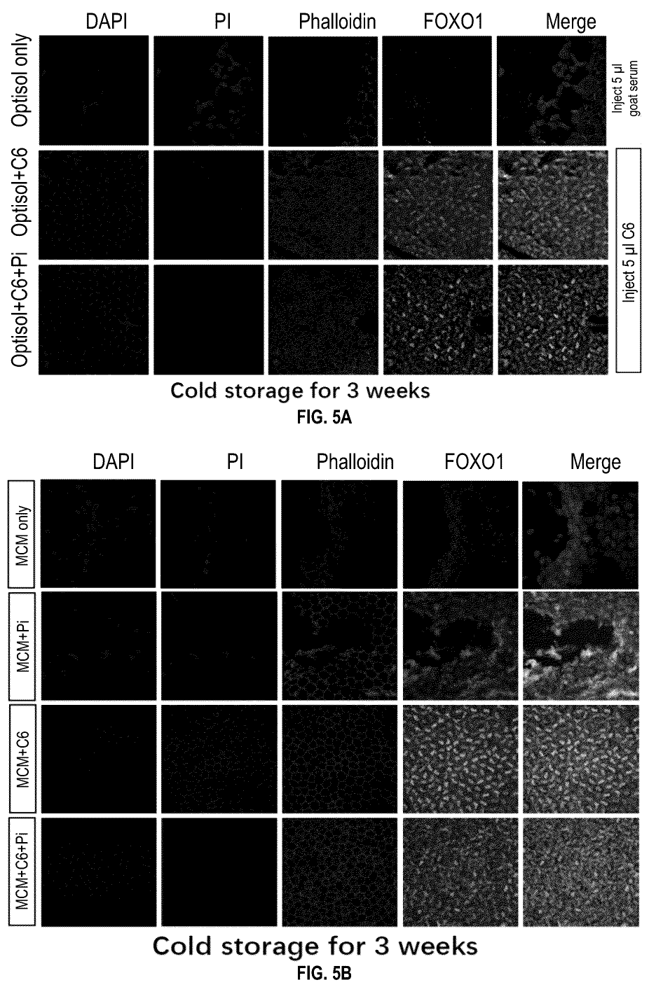

The results are shown in FIG. 5A-B. The corneal endothelial cell death rate of the group using the novel corneal preservation solution is lower than that of the group cold preserved in Optisol-GS™ (with and without C6 added). In contrast to the group without C6, there was a reduction in the number of dead corneal endothelial cells after the addition of C6. Furthermore, the corneal endothelial cells in the corneal preservation solution comprising C6 combined with Pi retained a better hexagonal structure than those with just C6 added. The Optisol-GS™ solution plus C6 demonstrated F-actin degradation. FIG. 5A suggests that C6 and Pi can be added into Optisol-GS™ and enhance rat corneal endothelial cell survival. FIG. 5B suggests that C6 and Pi can be added into the novel corneal preservation solution (MCM) and enhance rat corneal endothelial cell survival.

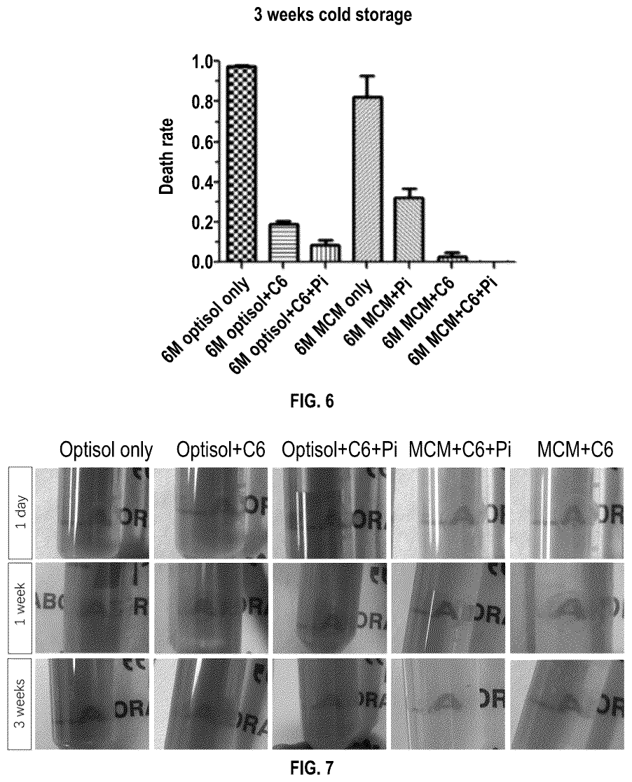

The mortality of each group was counted by counting the number of PI positive cells in the total number of cells in the visual field, and as a result, as shown in FIG. 6, it was found that the mortality of cells in Optisol-GS™ was nearly 100% after 3 weeks of preservation, and many endothelial cells were rescued after the use of C6 and Pi, with the mortality rates of 18.9% and 8.5%, respectively. The mortality rate of the endothelial cells in the novel corneal preservation solution is lower than that for Optisol™, and the mortality rate of the endothelial cells in the novel corneal preservation solution, plus C6 and Pi group, is 0.18%.

To compare corneal permeability, pictures of the “A” character observed through the cornea was recorded. As shown in FIG. 7, the cornea treated with the novel preservation solution plus C6 and Pi maintained a constant permeability after 3 weeks of cold storage, and the novel preservation solution plus just C6 comes in second. The cornea edema of the cornea treated with Optisol-GS™ caused blurriness where the clear letter “A” was not visible.

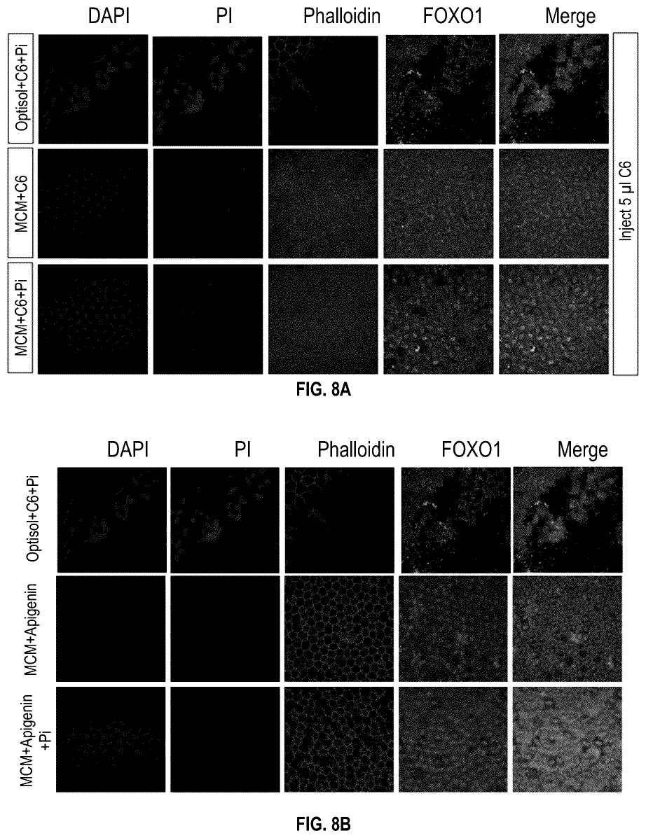

In order to further test the effects seen, the group with better cold preservation effect for 3 weeks is selected, and the cold preservation time is prolonged to 4 weeks. As shown in FIGS. 8A and 8B, rat corneas can be stored at 4° C. for 28 days with a largely intact endothelium. Even with C6 and Pi added, rat corneas stored in Optisol-GS™ still had higher mortality rate. The corneal endothelial cells still had higher mortality rate using the Optisol-GS™, while the corneal endothelial cells in the novel corneal preservation solution (with C6 and Pi) had a decreased mortality, as the corneal endothelial cells were maintained in a better hexagonal structure. The novel corneal fluid is added with F-actin of C6 group to form block. The novel corneal preservation solution with C6 demonstrates F-actin in a mass.

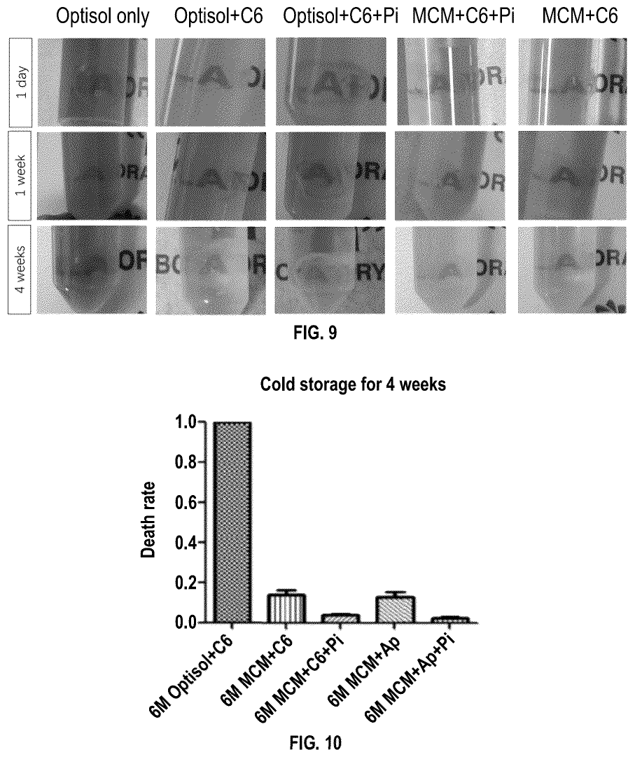

Permeability comparisons show that the cornea using the novel corneal preservation solution (with C6 and Pi) can still maintain a certain permeability after 4 weeks, while the cornea using Optisol-GS™ (with C6 and Pi) and the novel corneal preservation solution (with C6), demonstrates that the edges are blurred and difficult to distinguish for the letter “A” (FIG. 9).

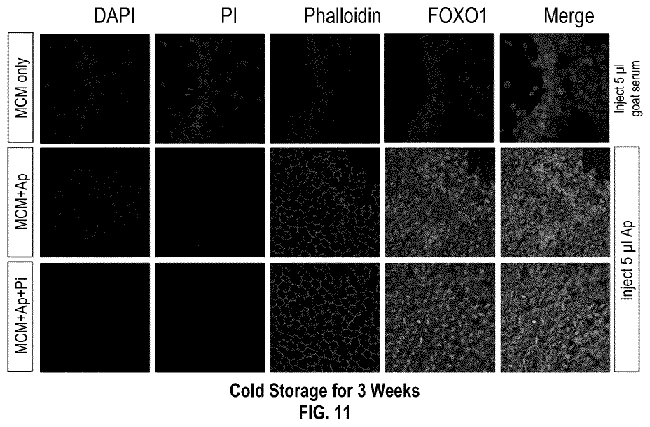

The ratio of dead endothelial cells were counted, and found that the novel corneal preservation solution (with C4 and Pi) resulted in the best effect after 4 weeks of cold storage, with a corneal endothelial cell death rate was about 14.3% (FIG. 10).

(2) Apigenin

0.5 μL of Apigenin solution (concentration 4 μM/μL, in goat serum solvent) was injected into the anterior chamber through the limbal stroma, and 20 minutes later, the cornea was removed and stored in the novel preservation solution prepared in Example 3 (with 4 μM Apigenin and Pi previously added). After cold storage for 3 weeks and 4 weeks, the cold storage results were evaluated by immunofluorescence staining.

Based on the results of C6, a novel corneal preservation solution plus Apigenin was compared to a novel corneal preservation solution plus Apigenin and Pi. As a result, as shown in FIG. 11, corneal endothelial cells demonstrated decreased mortality after the application of Apigenin. The cells in the novel corneal preservation solution with Apigenin and Pi demonstrated better hexagonal structure of the corneal endothelium. However, the cornea endothelium demonstrated partial damage when preserved in the novel corneal preservation solution with just Apigenin.

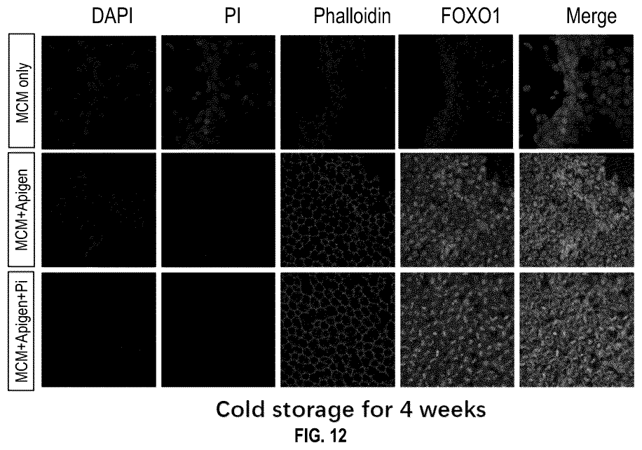

The cold storage time was then extended to 4 weeks. The data show that rat corneas can be stored at 4° C. for 28 days with a largely intact endothelium. FIG. 12 demonstrate that after Apigenin was added, the cell nucleus shows a full/plump shape, the PI positive cells (PI stains dead cells) were significantly reduced. When combined with Pi, the corneal endothelial cells retained a better hexagonal structure. However, the nuclei of the cells preserved in the novel corneal preservation solution and Apigenin showed slight pyknosis (slight shrinkage shape).

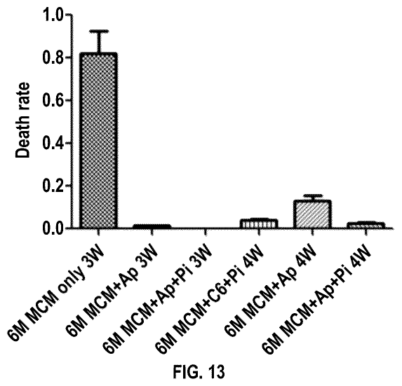

According to the data (FIG. 13), the novel corneal preservation solution plus Apigenin and Pi demonstrates good preservation effect in 3 weeks. By 4 weeks, the novel corneal preservation solution plus Apigenin and Pi demonstrates a mortality rate of only 2.5%.

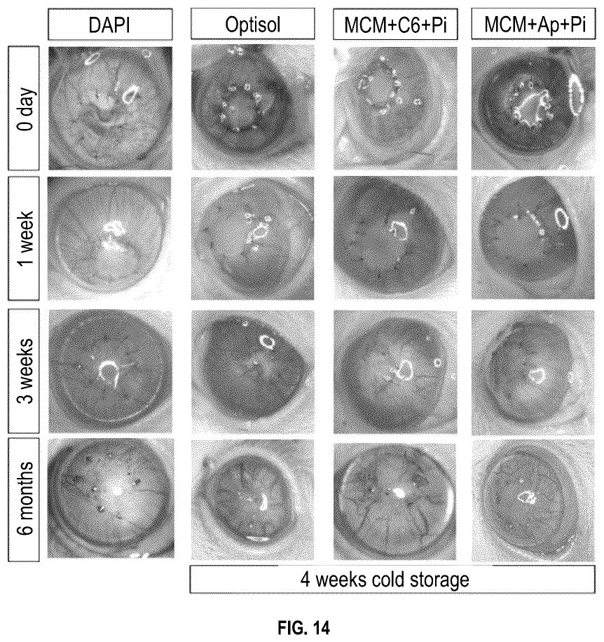

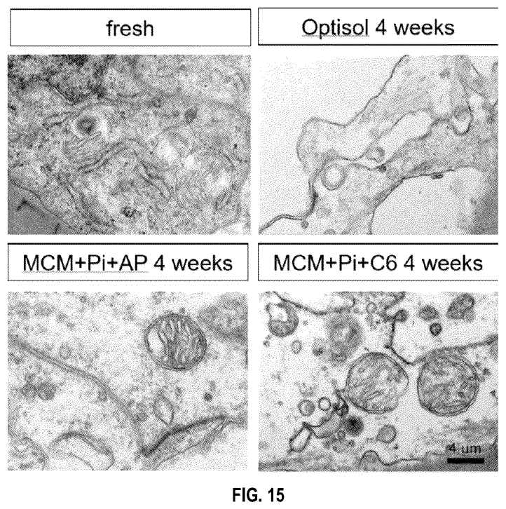

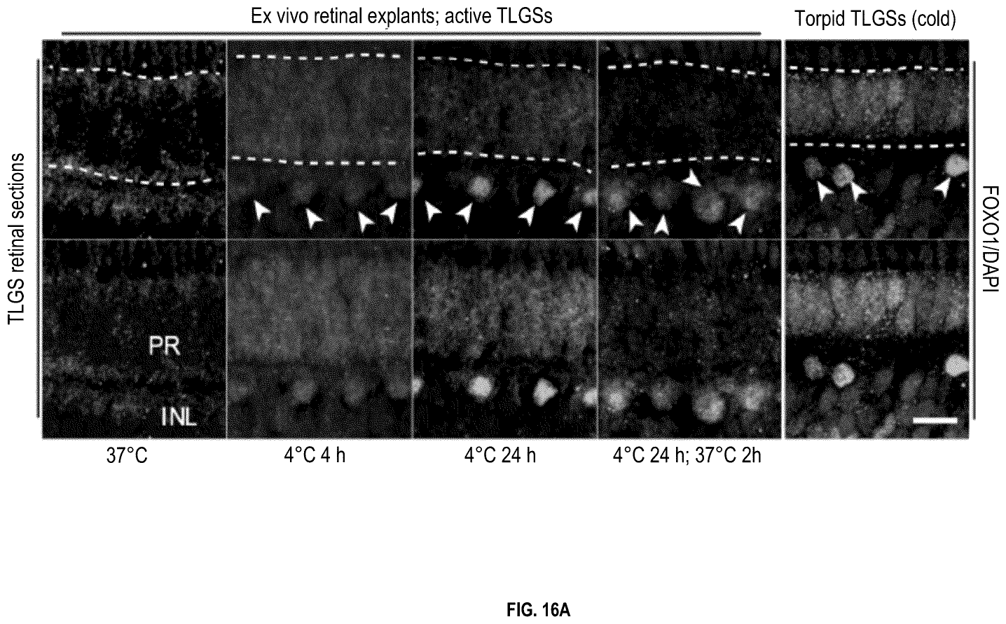

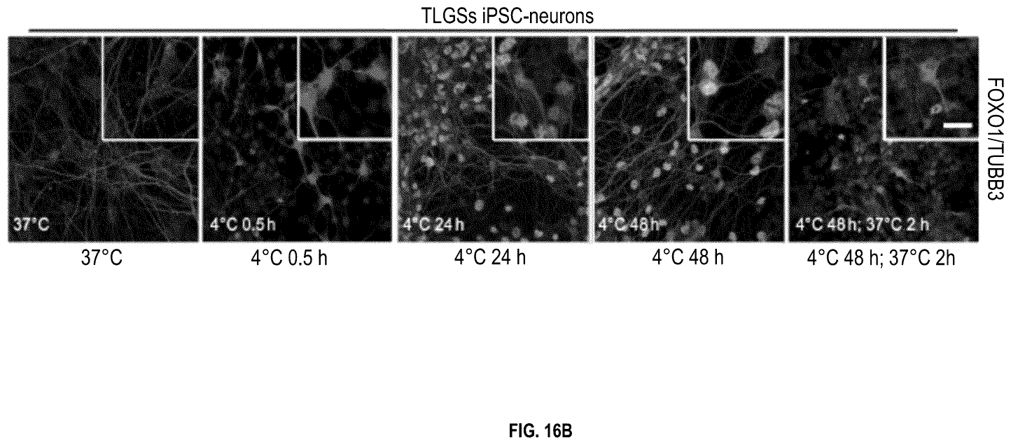

After preserving corneas of 6-month-old rats for 4 weeks using either C6 or Apigenin in combination with Pi in the novel corneal preservation solution, corneal transplantation was performed. Post-operative observations (FIG. 14) revealed that within 1 week post-implantation, the transplanted corneal sheet slowly healed, and by the third week, the fresh corneal sheet healed completely and was clear/translucent. The corneal sheet that was cold stored with Optisol-GS™ for 4 weeks was atrophied, whitened, and showed scar healing (showing signs of degeneration and more severe inflammation); the cornea using the novel preservation solution with C6 in combination with Pi for 4 weeks was slightly cloudy/turbid but generally good; the cornea using the novel preservation solution with Apigenin in combination with Pi after 4 weeks was slightly cloudy/turbid but still had good transparency. As seen in FIG. 15, transmission electron microscopy micrographs show poor corneal endothelial subcellular structures in the cornea stored with Optisol-GS™; Except for the ‘fresh’ cornea control, the other 3 groups were from cold-stored corneas 6 months after the transplantation surgery.

In conclusion, the inventors have developed a novel cornea cold preservation strategy. The novel corneal preservation solution plus C6 or Apigenin and optionally combined with Pi all have good cold preservation effect, with the novel corneal preservation solution plus Apigenin or C6 and Pi group the best preservation effect in 4 weeks, the death rate of corneal endothelial cells is only 2.5%, and transplantation operation can be carried out, and the postoperative has good transparent brightness.

### Example 7—Novel Preservation Solution Demonstrates Effective in Different Tissues and Species

The inventor found that the novel preservation solution can achieve the effect of improving the cold preservation effect on cells of different tissues and different species.

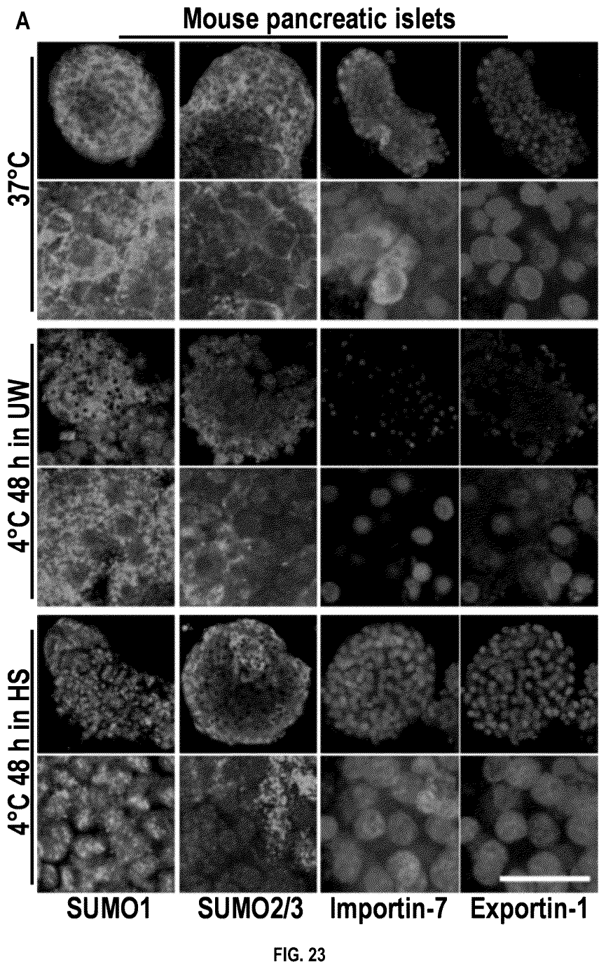

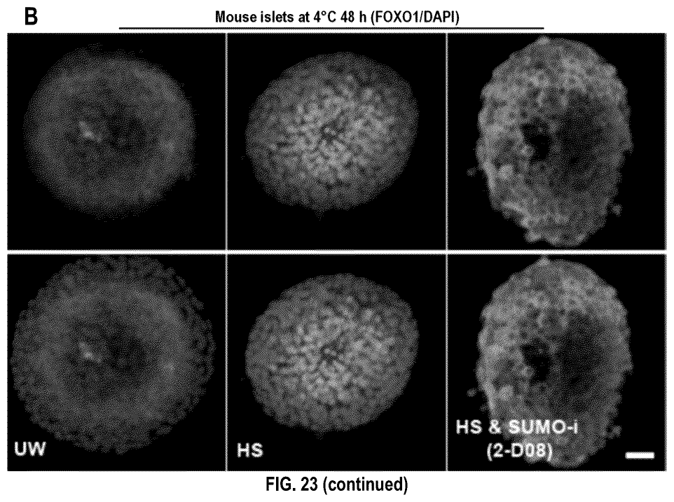

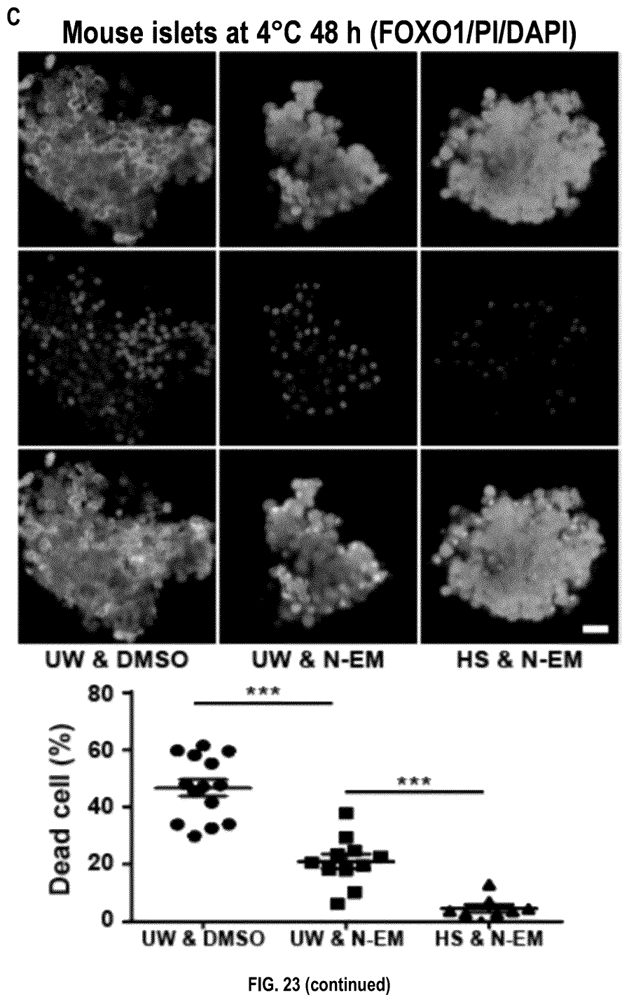

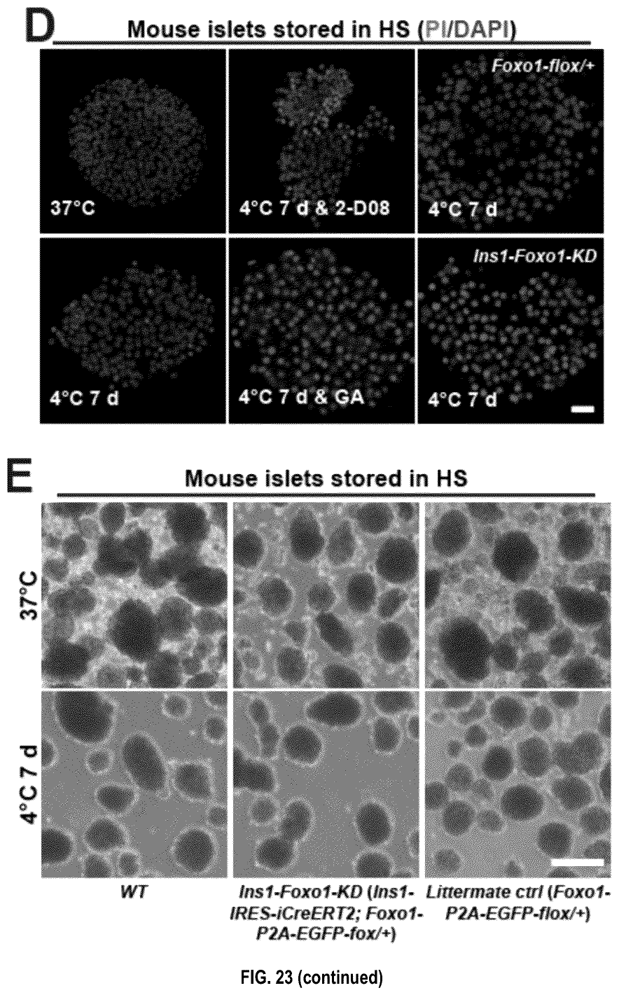

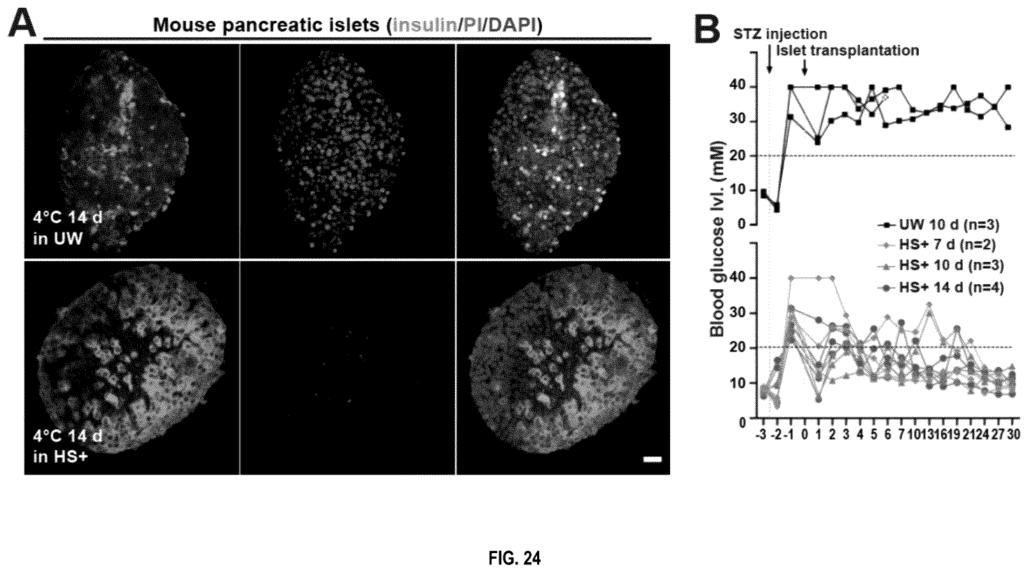

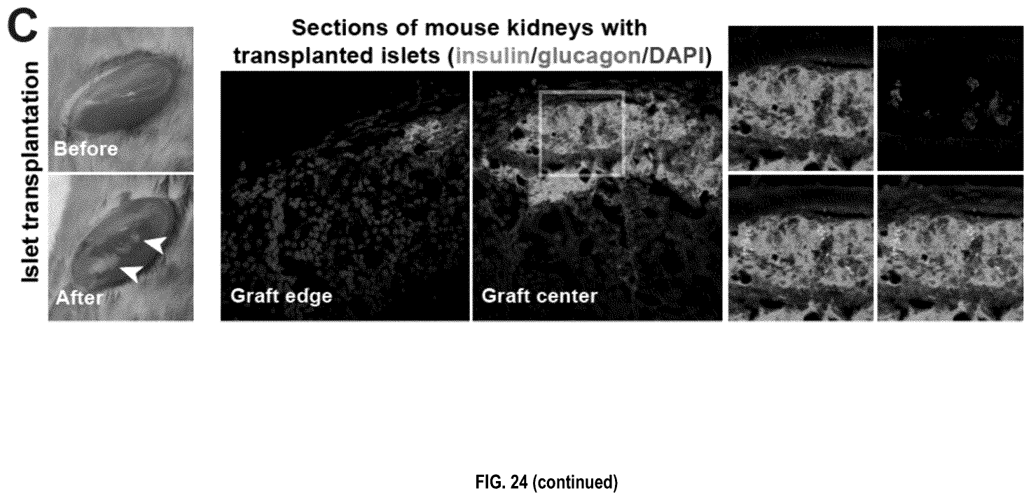

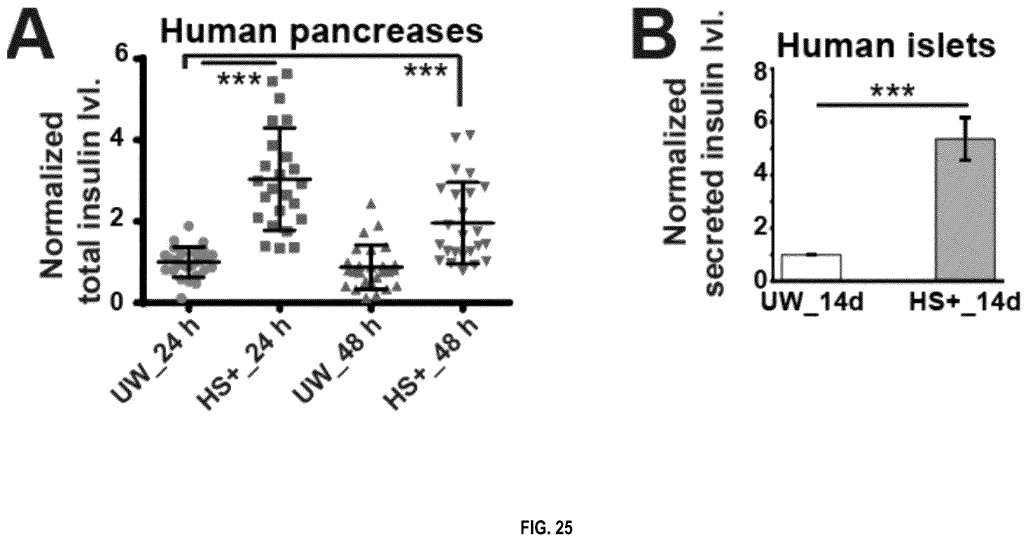

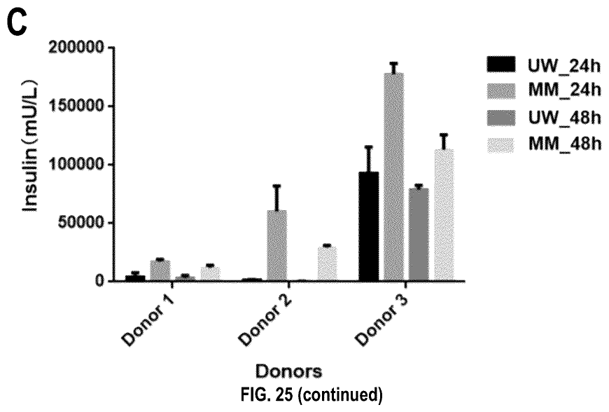

Using mouse pancreatic islets as a model, it can be seen from FIG. 23A-E that 1) the key components in the FOXO1-dependent survival pathway are NOT well maintained in the current gold standard organ preservation solution (UW, University of Wisconsin solution); 2) If the deSUMOylation inhibitor N-Ethylmaleimide (N-EM; see FIG. 23C) was added into the UW solution, islet cold survival is improved; if a basal preservation solution we developed (HS) was used, islet cold survival is even better; 3) Even in the HS solution, if SUMOylation inhibitor 2-D08 or ginkgolic acid (GA, see FIGS. 23 B and D) was added, cold-induced FOXO1 nuclear entry was repressed, and islet cell death became severe. N-EM and protease inhibitors are added into HS to make HS+. It can be seen from FIG. 26A-C that mouse islets can be stored in HS+ for up to 14 days at 4° C., transplanted into streptozotocin (STZ)-induced type I diabetic mice and successfully reduce the blood glucose levels of the recipient mice. As seen from FIG. 25A-B, HS+ can significantly improve the quality of human islets after prolonged cold storage.

In another example, mice pancreatic islets were extracted and stored at 4° C. in cold storage. The conventional 1640 culture solution which is commonly used is used as a control group. As a result, islet cells died in large numbers in 1640 culture solution, whereas islet cells died less in the novel preservation solution (MM), and the addition of islets with C6 and Apigenin further reduced the number of dead cells.

In another example, human pancreases were cold stored, and 50 mg of pancreatic tissue was extracted at both the 24-hour and 48-hour time points and insulin content was measured by chemiluminescence. The results are shown in FIG. 25C. Compared with the clinically used classic UW preservation solution, the pancreatic insulin content was higher for the pancreas cold stored in the novel preservation solution of the present invention at both the 24-hour and 48-hour time points, and the preservation effect of the novel preservation solution was better.

This demonstrates that the novel preservation solution has application prospects across different organizations and different species.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable.

“Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein. Unless defined otherwise, technical and scientific terms used herein have the same meaning as is commonly understood by one of skill in the art of this disclosure.

Furthermore, the disclosure encompasses all variations, combinations, and permutations in which one or more limitations, elements, clauses, and descriptive terms from one or more of the listed claims are introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of treating a cell, tissue, or organ to withstand exposure to a low temperature environment, the method comprising:
providing the cell, tissue, or organ to be exposed to the low temperature environment; and
contacting the cell, tissue, or organ with a composition comprising a compound which activates FOX01 protein in the cell, tissue, or organ, to enable the cell, tissue, or organ to withstand exposure to the low temperature.

2. The method of claim 1, further comprising
exposing the contacted cell, tissue, or organ to the low temperature environment.

3. The method of claim 1, wherein the cell, tissue, or organ is a cornea or a corneal cell.

4. (canceled)

5. The method of claim 1, wherein the compound which activates FOX01 protein is a cell permeable ceramide analog or Apigenin.

6. The method of claim 1, wherein compound which activates FOX01 protein is a cell permeable ceramide analog.

7. The method of claim 6, wherein the cell permeable ceramide analog is a compound represented by Formula 1 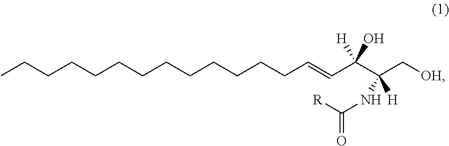
wherein R is a C1 to C9 alkyl group.

8. The method of claim 6, wherein the cell permeable ceramide analog is a compound represented by Formula 2

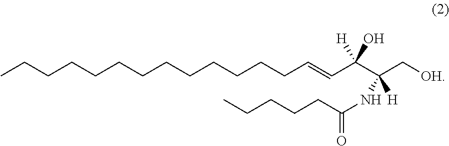 [SMILES: CCCCCCCCCCCCC/C=C/[C@@H](O)[C@H](CO)NC(=O)CCCCC]

9. The method of claim 6, wherein a concentration of the cell permeable ceramide analog in the composition is 0.1 μM to 100 μM.

10. The method of claim 6, wherein a concentration of the cell permeable ceramide analog in the composition is 2 μM to 20 μM.

11. The method of claim 1, wherein the compound which activates FOX01 protein is Apigenin.

12. The method of claim 11, wherein a concentration of the Apigenin in the composition is 0.1 μM to 30 μM.

13. The method of claim 11, wherein a concentration of the Apigenin in the composition is 0.1 μM to 10 μM.

14. The method of claim 1, wherein the composition further comprises a preservation solution.

15-16. (canceled)

17. The method of claim 1, wherein the preservation solution further comprises a protease inhibitor mixture (Pi) comprising 1-20 μM of an aspartic protease inhibitor and 2-40 μM of a serine and cysteine protease inhibitor, and optionally also comprises at least one of the following:
5-50 μM of metallo-protease inhibitor,
1.5-30 μM of cysteine protease inhibitor,
0.08-2 μM of serine protease inhibitor, and
10-100 μM of AEBSF (4-(2-aminoethyl) benzenesulfonyl fluoride hydrochloride).

18-19. (canceled)

20. The method of claim 1, wherein contacting of the cell, tissue, or organ with the composition occurs prior to and/or during exposure of the cell, tissue, or organ to the low temperature environment.

21. The method of claim 1, wherein contacting of the cell, tissue, or organ with the composition occurs before removal of the cell, tissue, or organ from the donor.

22. (canceled)

23. The method of claim 1, wherein contacting of the cell, tissue, or organ with the composition occurs after removal of the cell, tissue, or organ from the donor.

24-25. (canceled)

26. The method of claim 1, wherein after contacting the cell, tissue, or organ with the composition, the method further comprises maintaining the cell, tissue, or organ in the low temperature environment for a period of 1-4 weeks in the presence of the composition.

27. The method of claim 1, wherein the exposure to a low temperature environment comprises storage at a temperature of 2° C. to 8° C.

28-39. (canceled)

40. A preservation solution comprising the following components, in 1 L calculation:
amino acid:
Alanine 1.5-2.2 mg
Arginine 75-93 mg
Asparagine 14-17 mg
Cysteine 0.9-1.1 mg
Glycine 27-33 mg
Glutamine 180-220 mg
Histadine 28-34 mg
Isoleucine 94-120 mg
Leucine 94-120 mg
Lysine 100-130 mg
Methionine 27-33 mg
Phenylalanine 59-73 mg
Proline 7-8.5 mg
Serine 36-46 mg
Threonine 85-105 mg
Tryptophan 14-18 mg
Tyrosine 60-80 mg
Valine 84-105 mg
Vitamins:
Choline 4-5.2 mg
D-Calcium pantothenate 3-4.5 mg
Pantothenic acid (Vitamin B5) 0.9-1.1 mg
Folic acid 4-5 mg
Niacinamide 4-5 mg
Pyridoxal (Vitamin B6) 4-5 mg
Riboflavin (vitamin B2) 0.09-0.11 mg
Thiamine (Vitamin B1) 5-6.5 mg
Vitamin B12 1-1.5 mg
Inorganic salt:
CaCl₂ 170-220 mg
Fe(NO₃)₃ 50-70 mg
KCl 360-440 mg
NaHCO₃ 66-85 mg
NaCl 4300-5300 mg
NaH₂PO₄ 120-160 mg
MgCl₂ 69-85 mg
ZnSO₄ 97-120 mg
Other components:
Adenosine 1.3-1.7 mg
Chondroitin sulfate 22000-28000 mg
Glucose 4000-5000 mg
Dextran 9000-11000 mg
Gentamicin 90-110 mg
Inosine 9-12 mg
Inositol 10-14 mg
Phenol red 330-420 mg
Pyridoxal Hydrochloride 0.9-1.1 mg
MES monohydrate 220-280 mg
MOPS buffer 9000-11000 μm
HEPES buffer 1800-2200 μm
Sodium pyruvate 0.9-1.2 mg
2-mercaptoethanol 3.4-4.3 mg,
wherein the preservation solution has a pH of 7.3±2, and an osmotic pressure of 300±50 mOsm.

41. (canceled)

42. The preservation solution of claim 41, further comprising at least one selected from the group consisting of a compound which activates FOX01 protein in the cell, tissue, or organ and a protease inhibitor mixture (Pi).

43. The preservation solution of claim 42, wherein the compound which activates FOX01 protein is a cell permeable ceramide analog or Apigenin.

44. The preservation solution of claim 42, wherein compound which activates FOX01 protein is a cell permeable ceramide analog.

45-47. (canceled)

48. The preservation solution of claim 44, wherein a concentration of the cell permeable ceramide analog in the solution is 2 to 20 μM/μL.

49. The preservation solution of claim 42, wherein the compound which activates FOX01 protein is Apigenin.

50. The preservation solution of claim 49, wherein a concentration of the Apigenin in the solution is 0.1 to 30 μM/μL.

51. The preservation solution of claim 49, wherein a concentration of the Apigenin in the solution is 0.1 to 10 μM/μL.

52-54. (canceled)

55. A method of treating a cell, tissue, or organ to withstand exposure to a low temperature environment, the method comprising:
providing the cell, tissue, or organ to be exposed to the low temperature environment; and
contacting the cell, tissue, or organ with the preservation solution of claim 40 to enable the cell, tissue, or organ to withstand exposure to the low temperature.

56. A method of preserving viability of a cell, tissue, or organ during exposure to a low temperature environment, the method comprising:
contacting the cell, tissue, or organ with the preservation solution of claim 40 to preserve the viability of the cell, tissue, or organ; and
exposing the contacted cell, tissue, or organ to the low temperature environment.

57-64. (canceled)

65. A composition comprising a compound which results in activation of FOXO1 in a cell, tissue, or organ and a preservation solution for low temperature cell, tissue, or organ storage,
wherein the composition preserves the viability of cell, tissue, or organ during exposure to a low temperature environment.

66-71. (canceled)

72. The composition of claim 65, wherein the compound which activates FOX01 protein is Apigenin.

73. The composition of claim 72, wherein a concentration of the Apigenin in the composition is 0.1 μM to 30 μM.
